(19) United States
(12) Patent Application Publication
(10) Pub. No.: US 2023/0319884 A1
(43) Pub. Date: Oct. 5, 2023

(54) WIRELESS COMMUNICATION METHOD USING MULTIPLE LINKS, AND WIRELESS COMMUNICATION TERMINAL USING SAME

(71) Applicant: WILUS INSTITUTE OF STANDARDS AND TECHNOLOGY INC., Gyeonggi-do (KR)

(72) Inventors: Geonjung KO, Gyeonggi-do (KR); Sanghyun KIM, Seoul (KR); Juhyung SON, Gyeonggi-do (KR); Jinsam KWAK, Gyeonggi-do (KR)

(21) Appl. No.: 18/013,634

(22) PCT Filed: Jun. 30, 2021
(86) PCT No.: PCT/KR2021/008310

§ 371 Date: Dec. 29, 2022

(30) Foreign Application Priority Data
Jun. 30, 2020 (KR) 10-2020-0080249
Jul. 7, 2020 (KR) 10-2020-0083783

(51) Int. Cl. H04W 74/08; H04W 72/1263

(52) U.S. Cl. CPC H04W 74/0816; H04W 74/0875; H04W 72/1263

(57) ABSTRACT

A multi-link device using a plurality of links is disclosed. A processor receives, in any one link of the plurality of links, a first physical layer protocol data unit (PPDU) including access category (AC) constraint signaling and a reverse direction (RD) grant from a station which is a transmission opportunity (TXOP) holder or a service period (SP) source, and transmits, in the any one link, a second PPDU to the station in response to the first PPDU on the basis of the AC constraint signaling. The AC constraint signaling indicates whether a traffic identifier (TID) or AC of a frame included in the second PPDU is constrained.

### TECHNICAL FIELD

The present invention relates to a wireless communication method using a multi-link and a wireless communication terminal using the same.

### BACKGROUND ART

In recent years, with supply expansion of mobile apparatuses, a wireless LAN technology that can provide a rapid wireless Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11n has come into the spotlight. Among them, IEEE 802.11ac supports a wide bandwidth (80 to 160 MHz) in the 5 GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHz), more MIMO spatial streams (a maximum of 8), multi-user MIMO, and high-density modulation (a maximum of 256 QAM). Further, as a scheme that transmits data by using a 60 GHz band instead of the existing 2.4 GHz/5 GHz, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band.

### DETAILED DESCRIPTION OF THE INVENTION

### Technical Problem

An embodiment of the present invention is for providing a wireless communication method using a multi-link and a wireless communication terminal using the same.

### Technical Solution

According to an embodiment of the disclosure, a multi-link device that uses a plurality of links may include a transceiver; and a processor. The processor may be configured to receive a first physical layer protocol data unit (PPDU) including reverse direction (RD) grant and an access category (AC) constraint signaling from a station that is a transmission opportunity (TXOP) holder or a service period (SP) source in any one of the plurality of links, and to transmit, based on the AC constraint signaling in the any one link, a second PPDU to the station in response to the first PPDU. The AC constraint signaling indicates whether a traffic identifier (TID) or AC of a frame to be included in the second PPDU is restricted.

An AC or a TID may be mapped to any one of the plurality of links, and the multi-link device may transmit a frame based on the mapped AC or TID in the any one link. In this instance, in the case that the AC constraint signaling indicates that any TID is allowed as a TID of a data frame to be included in the second PPDU, and the multi-link device includes a data frame in the second PPDU, the processor may be configured to include a data frame corresponding to a TID mapped to the any one link in the second PPDU, and not to include a data frame corresponding to a TID that is not mapped to the any one link in the second PPDU.

An AC or a TID is mapped to any one of the plurality of links, and the multi-link device may transmit a frame based on the mapped AC or TID in the any one link. In this instance, in the case that the AC constraint signaling indicates that an AC or TID of a frame to be included in the second PPDU is restricted, and the multi-link device includes a data frame in the second PPDU, the processor may be configured to include, in the second PPDU, a data frame corresponding to an AC or a TID that is mapped to the any one link and that has a priority higher than or equal to a priority of an AC or TID of a frame received from the station, and not to include, in the second PPDU, a data frame corresponding to a TID or AC that is not mapped to the any one link or has a lower priority than the priority of the AC or TID of the frame received from the station.

When the multi-link device receives a plurality of frames from the station, the priority of the AC or TID of the frame received from the station is the lowest priority among priorities of the plurality of frames.

The processor may regard an AC of a management frame as a predetermined value.

In the case that the multi-link device is to include a BlockAck frame in the second PPDU, the processor may determine an AC of the BlockAck frame based on a TID field of the BlockAck frame. In addition, in the case that the multi-link device is to include a BlockAckReq frame in the second PPDU, the processor may determine an AC of the BlockAckReq frame based on a TID field of the BlockAckReq frame.

The AC constraint signaling may be included in a medium access control (MAC) header of a frame included in a PPDU that includes the RD grant.

According to an embodiment of the disclosure, an operation method of a multi-link device that uses a plurality of links may include an operation of receiving a first physical layer protocol data unit (PPDU) including reverse direction (RD) grant and an access category (AC) constraint signaling from a station that is a transmission opportunity (TXOP) holder or a service period (SP) source in any one of the plurality of links; and an operation of transmitting, based on the AC constraint signaling in the any one link, a second PPDU to the station in response to the first PPDU. The AC constraint signaling may indicate whether a traffic identifier (TID) or AC of a frame to be included in the second PPDU is restricted.

An AC or a TID may be mapped to any one of the plurality of links, and the multi-link device may transmit a frame based on the mapped AC or TID in the any one link. In this instance, the operation of transmitting the second PPDU to the station may include a data frame corresponding to a TID mapped to the any one link in the second PPDU, and not including a data frame corresponding to a TID that is not mapped to the any one link in the second PPDU, in the case that the AC constraint signaling indicates that any TID is allowed as a TID of a data frame to be included in the second PPDU, and the multi-link device includes a data frame in the second PPDU.

An AC or a TID may be mapped to any one of the plurality of links, and the multi-link device may transmit a frame based on the mapped AC or TID in the any one link. In this instance, the operation of transmitting the second PPDU to the station may include an operation of including, in the second PPDU, a data frame corresponding to an AC or a TID that is mapped to the any one link and that has a priority higher than or equal to a priority of an AC or a TID of a frame received from the station, and not including, in the second PPDU, a data frame corresponding to a TID or AC that is not mapped to the any one link or has a lower priority than the priority of the AC or TID of the frame received from the station, in the case that the AC constraint signaling indicates that an AC or a TID of a frame to be included in the second PPDU is restricted, and the multi-link device includes a data frame in the second PPDU.

When the multi-link device receives a plurality of frames from the station, the priority of the AC or TID of the frame received from the station may be the lowest priority among priorities of the plurality of frames.

The operation of transmitting the second PPDU to the station may include an operation of regarding an AC of a management frame as a predetermined value.

The operation of transmitting the second PPDU to the station may include an operation of determining an AC of the BlockAck frame based on a TID field of the BlockAck frame in the case that the multi-link device is to include a BlockAck frame in the second PPDU, and an operation of determining an AC of the BlockAckReq frame based on a TID field of the BlockAckReq frame in the case that the multi-link device is to include a BlockAckReq frame in the second PPDU. The AC constraint signaling may be included in a medium access control (MAC) header of a frame included in a PPDU including the RD grant.

### Advantageous Effects

An embodiment of the disclosure provides a wireless communication method that efficiently uses multiple links and a wireless communication terminal using the same.

### BRIEF DESCRIPTION OF DRAWINGS

FIG. 1 illustrates a wireless LAN system according to an embodiment of the present invention.

FIG. 2 illustrates a wireless LAN system according to another embodiment of the present invention.

FIG. 3 illustrates a configuration of a station according to an embodiment of the present invention.

FIG. 4 illustrates a configuration of an access point according to an embodiment of the present invention.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates an example of a format of a PLCP Protocol data unit (PPDU) for each of various standard generations.

FIG. 8 illustrates an example of various extremely high throughput (EHT) physical protocol data unit (PPDU) formats and a method for indicating the same according to an embodiment of the present invention.

FIG. 9 illustrates a multi-link device according to an embodiment of the disclosure.

FIG. 10 is a diagram illustrating frame exchange performed between a non-AP multi-link device and an AP multi-link device in the case that TID-to-link mapping is configured according to an embodiment of the disclosure.

FIG. 11 is a diagram illustrating frame exchange performed based on a reverse direction (RD) protocol according to an embodiment of the disclosure.

FIG. 12 is a diagram illustrating AC constraint signaling according to an embodiment of the disclosure.

FIG. 13 is a diagram illustrating a format of a frame and a format of a signaling field of a frame according to an embodiment of the disclosure.

FIG. 14 is a diagram illustrating RD exchange performed, when AC constraint is not applied, in a link to which TID-to-link mapping is applied according to an embodiment of the disclosure.

FIG. 15 is a diagram illustrating RD exchange performed, when AC constraint is not applied, in a link to which TID-to-link mapping is applied according to another embodiment of the disclosure.

FIG. 16 is a diagram illustrating an example of not applying AC constraint when RD exchange is performed in a link to which TID-to-link mapping is applied according to another embodiment of the disclosure.

FIG. 17 is a diagram illustrating RD exchange performed, when AC constraint is applied, in a link to which TID-to-link mapping is applied according to another embodiment of the disclosure.

FIG. 18 is a diagram illustrating RD exchange performed, when AC constraint is applied, in a link to which TID-to-link mapping is applied according to another embodiment of the disclosure.

FIG. 19 is a diagram illustrating that an RD initiator signals information associated with AC constraint used in RD responding according to an embodiment of the disclosure.

FIG. 20 is a diagram illustrating RD exchange performed, when PPDUs of which termination of transmission is synchronized are transmitted in a plurality of links according to an embodiment of the disclosure.

FIG. 21 is a diagram illustrating the configuration of an RU capable of being allocated to a single station according to IEEE 802.11ax and the configuration of an RU capable of being allocated to a single station according to an embodiment of the disclosure.

FIG. 22 is a diagram illustrating an OFDMA DL PPDU used in the IEEE 802.11ax standard and an OFDMA DL PPDU used in an embodiment of the disclosure.

FIG. 23 is a diagram illustrating a backoff procedure performed using a subchannel as opposed to a 20 MHz-primary channel according to an embodiment of the disclosure.

FIG. 24 is a diagram illustrating that the length of a PPDU is restricted when a station successfully performs channel access in a subchannel as opposed to a 20 MHz-primary channel according to an embodiment of the disclosure.

FIG. 25 is a diagram illustrating that a station performs channel access via a subchannel of a segment that is not a main segment, when a 20 MHz-primary channel is not idle according to an embodiment of the disclosure.

FIG. 26 is a diagram illustrating that a first AP of a multi-link device signals, via a second AP, that the first AP is capable of performing reception via a subchannel as opposed to a 20 MHz-primary channel according to an embodiment of the disclosure.

FIG. 27 is a diagram illustrating that an AP of an AP multi-link device allows a station, which is parked in a segment that does not correspond to an 80 MHz-primary channel, to perform a backoff procedure for uplink transmission in the segment in which the station is parked, according to an embodiment.

### MODE FOR CARRYING OUT THE INVENTION

Terms used in the specification adopt general terms which are currently widely used by considering functions in the present invention, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively.

Hereinafter, in the present invention, a field and a subfield may be interchangeably used.

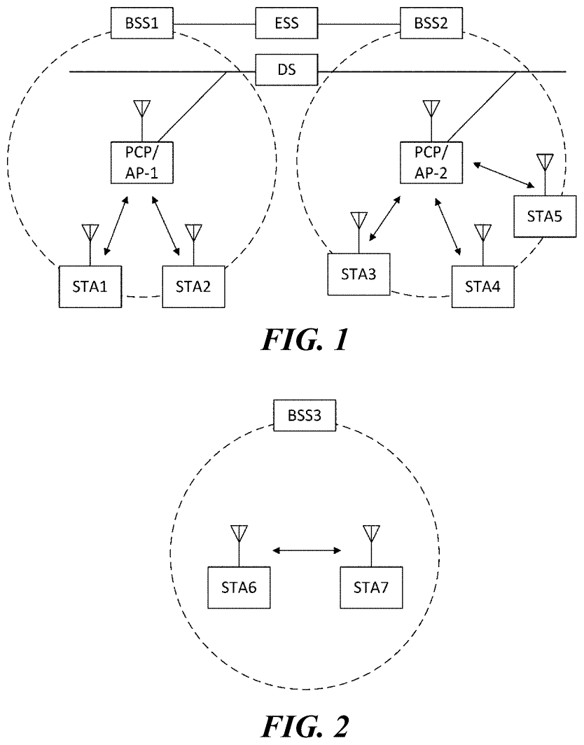

FIG. 1 illustrates a wireless LAN system according to an embodiment of the present invention.

FIG. 1 is a diagram illustrating a wireless LAN system according to an embodiment of the present invention. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present invention, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present invention, the AP is used as a concept including a personal BSS coordination point (PCP) and may include concepts including a centralized controller, a base station (BS), a node-B, a base transceiver system (BTS), and a site controller in a broad sense. In the present invention, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

FIG. 2 illustrates an independent BSS which is a wireless LAN system according to another embodiment of the present invention. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

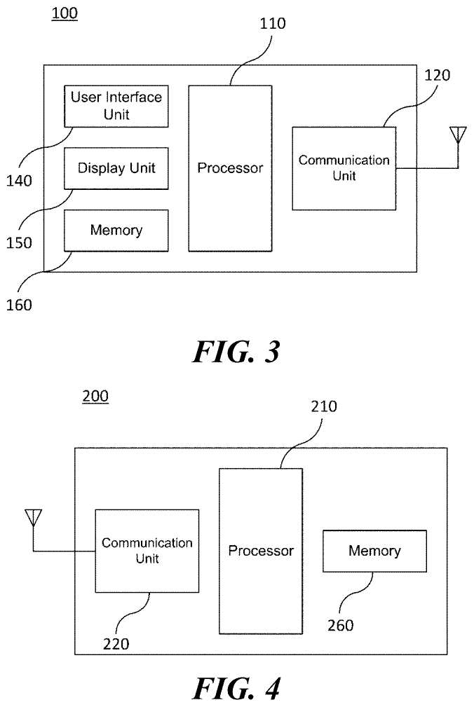

FIG. 3 is a block diagram illustrating a configuration of a station 100 according to an embodiment of the present invention. As illustrated in FIG. 3, the station 100 according to the embodiment of the present invention may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHz, 6 GHz and 60 GHz. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present invention, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present invention may execute various commands or programs and process data in the station 100. Further, the processor 110 may control the respective units of the station 100 and control data transmission/reception among the units. According to the embodiment of the present invention, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present invention may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present invention. A detailed embodiment thereof will be described below.

The station 100 illustrated in FIG. 3 is a block diagram according to an embodiment of the present invention, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present invention, some components of the station 100, for example, the user interface unit 140 and the display unit 150 may be optionally provided in the station 100.

FIG. 4 is a block diagram illustrating a configuration of an AP 200 according to an embodiment of the present invention. As illustrated in FIG. 4, the AP 200 according to the embodiment of the present invention may include a processor 210, a communication unit 220, and a memory 260. In FIG. 4, among the components of the AP 200, duplicative description of parts which are the same as or correspond to the components of the station 100 of FIG. 2 will be omitted.

Referring to FIG. 4, the AP 200 according to the present invention includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present invention may include two or more communication modules among different frequency bands, for example, 2.4 GHz, 5 GHz, 6 GHz and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present invention, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present invention, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present invention. A detailed embodiment thereof will be described below.

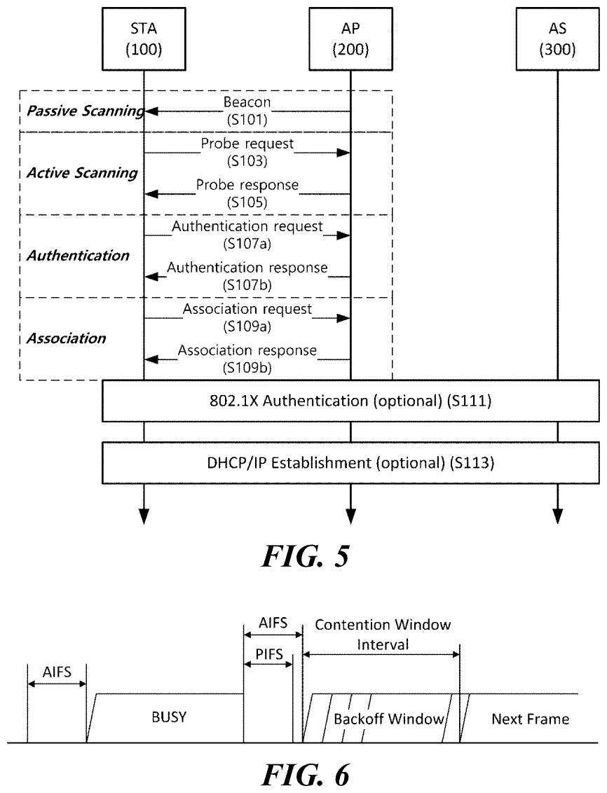

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present invention is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval. In this instance, a random number is referred to as a backoff counter. That is, the initial value of the backoff counter may be set by an integer number which is a random number that a UE obtains. In the case that the UE detects that a channel is idle during a slot time, the UE may decrease the backoff counter by 1. In addition, in the case that the backoff counter reaches 0, the UE may be allowed to perform channel access in a corresponding channel. Therefore, in the case that a channel is idle during an AIFS time and the slot time of the backoff counter, transmission by the UE may be allowed.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

### <Examples of Various PPDU Formats>

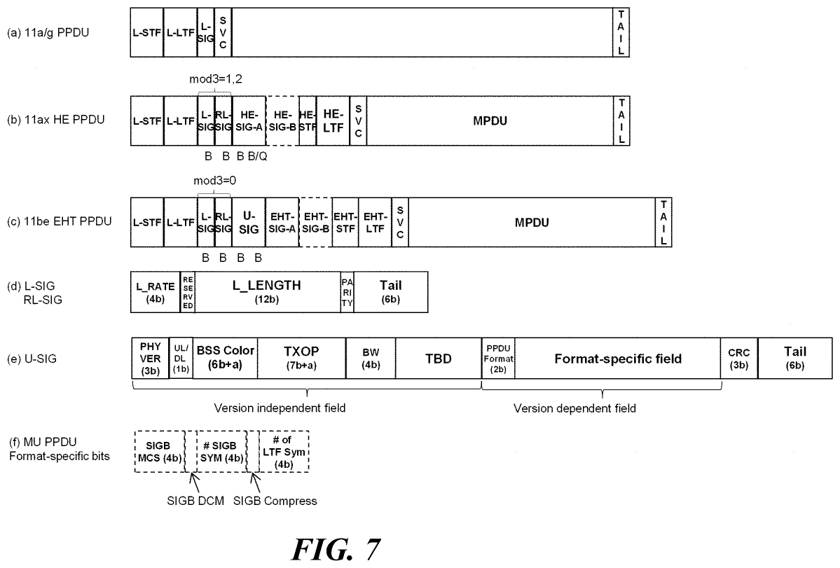

FIG. 7 illustrates an example of a format of a PLCP Protocol data unit (PPDU) for each of various standard generations. More specifically, FIG. 7(a) illustrates an embodiment of a legacy PPDU format based on 802.11a/g, FIG. 7(b) illustrates an embodiment of an HE PPDU format based on 802.11ax, and FIG. 7(c) illustrates an embodiment of a non-legacy PPDU (i.e., EHT PPDU) format based on 802.11be. FIG. 7(d) illustrates detailed field configurations of RL-SIG and L-SIG commonly used in the PPDU formats.

Referring to FIG. 7(a), a preamble of the legacy PPDU includes a legacy short training field (L-STF), a legacy long training field (L-LTF), and a legacy signal field (L-SIG). In an embodiment of the present invention, the L-STF, the L-LTF, and the L-SIG may be referred to as a legacy preamble.

Referring to FIG. 7(b), a preamble of the HE PPDU additionally includes, in the legacy preamble, a repeated legacy short training field (RL-SIG), a high efficiency signal A field (HE-SIG-A), a high efficiency signal B field (HE-SIG-B), a high efficiency short training field (HE-STF), and a high efficiency long training field (HE-LTF). In an embodiment of the present invention, the RL-SIG, HE-SIG-A, the HE-SIG-B, the HE-STF and the HE-LTF may be referred to as an HE preamble. A specific configuration of the HE preamble may be modified according to an HE PPDU format. For example, HE-SIG-B may be used only in an HE MU PPDU format.

Referring to FIG. 7(c), a preamble of the EHT PPDU additionally includes, in the legacy preamble, a repeated legacy short training field (RL-SIG), a universal signal field (U-SIG), and an extremely high throughput signal A field (EHT-SIG-A), an extremely high throughput signal B field (EHT-SIG-B), an extremely high throughput short training field (EHT-STF), and an extremely high throughput long training field (EHT-LTF). In an embodiment of the present invention, the RL-SIG, EHT-SIG-A, the EHT-SIG-B, the EHT-STF and the EHT-LTF may be referred to as an EHT preamble. A specific configuration of a non-legacy preamble may be modified according to an EHT PPDU format. For example, EHT-SIG-A and EHT-SIG-B may be used only in a part of the EHT PPDU format.

64-FFT OFDM is applied in an L-SIG field included in the preamble of the PPDU, and the L-SIG field includes a total of 64 subcarriers. Among 64 subcarriers, 48 subcarriers excluding a guard subcarrier, a DC subcarrier, and a pilot subcarrier are used for transmission of L-SIG data. BPSK and a modulation and coding scheme (MCS) of rate=1/2 are applied in L-SIG, and therefore the L-SIG may include a total of 24 bits of information. FIG. 7(d) illustrates a 24-bit information configuration of L-SIG.

Referring to FIG. 7(d), the L-SIG includes an L_RATE field and an L_LENGTH field. The L_RATE field includes 4 bits and indicates an MCS used for data transmission. Specifically, the L_RATE field indicates one value among transmission rates of 6/9/12/18/24/36/48/54 Mbps obtained by combining a modulation scheme of BPSK/QPSK/16-QAM/64-QAM, etc. and an inefficiency of 1/2, 2/3, 3/4, etc. A total length of a corresponding PPDU may be indicated by combining information of the L_RATE field and information of the L_LENGTH field. In a non-legacy PPDU format, the L_RATE field is configured to a minimum rate of 6 Mbps.

A unit of the L_LENGTH field is a byte and a total of 12 bits are allocated to signal up to 4095, and a length of the PPDU may be indicated in combination with the L_RATE field. A legacy terminal and a non-legacy terminal may interpret the L_LENGTH field in different ways.

First, a method of interpreting the length of a PPDU using a L_LENGTH field by a legacy terminal or a non-legacy terminal is as follows. When the L_RATE field is set to 6 Mbps, 3 bytes (i.e., 24 bits) can be transmitted for 4 us, which is one symbol duration of 64 FFT. Therefore, by adding 3 bytes corresponding to the SVC field and the Tail field to the value of the L_LENGTH field and dividing it by 3 bytes, which is the transmission amount of one symbol, the number of symbols after the L-SIG is obtained on the 64FFT basis. The length of the corresponding PPDU, that is, the reception time (i.e., RXTIME) is obtained by multiplying the obtained number of symbols by 4 us, which is one symbol duration, and then adding a 20 us which is for transmitting L-STF, L-LTF and L-SIG. This can be expressed by the following Equation 1.

$$RXTIME ( us ) = ( ⌈ \frac{L\_LENGTH + 3}{3} ⌉ ) \times 4 + 20 \qquad [ Equation 1 ]$$

In this case, denotes the smallest natural number greater than or equal to x. Since the maximum value of the L_LENGTH field is 4095, the length of the PPDU can be set up to 5.464 ms. The non-legacy terminal transmitting the PPDU should set the L_LENGTH field as shown in Equation 2 below.

$$L\_LENGTH ( byte ) = ( ⌈ \frac{TXTIME - 20}{4} ⌉ ) \times 3 - 3 \qquad [ Equation 2 ]$$

Herein, TXTIME is the total transmission time constituting the corresponding PPDU, and is expressed by Equation 3 below. In this case, TX represents the transmission time of X.

TXTIME (us)=T_{L-STF}+T_{L-LTF}+T_{L-SIG}+T_{RL-SIG}+T_{U-SIG}+(T_{EHT-SIG-A})+(T_{EHT-SIG-B})+T_{EHT-STF}+N_{EHT-LTF}·T_{EHT-LTF}+T_{DATA} [Equation 3]

Referring to the above equations, the length of the PPDU is calculated based on a rounded up value of L_LENGTH/3. Therefore, for a random value of k, three different values of L_LENGTH={3k+1, 3k+2, 3(k+1)} indicate the same PPDU length.

Referring to FIG. 7(e), a universal SIG (U-SIG) field continues to exist in an EHT PPDU and a WLAN PPDU of a subsequent generation, and serves to classify a generation of a PPDU, which includes 11be. U-SIG is a 64 FFT-based OFDM 2 symbol and may transfer a total of 52 bits of information. In 52 bits, 43 bits excluding 9 bits for CRC/Tail are largely divided into a version independent (VI) field and a version dependent (VD) field.

A VI bit enables a current bit configuration to be maintained even later on, so that even if a PPDU of a subsequent generation is defined, current 11be terminals may obtain information on the PPDU via the VI fields of the PPDU. To this end, the VI field includes PHY version, UL/DL, BSS color, TXOP, and reserved fields. The PHY version field is 3 bits, and serves to sequentially classify 11be and subsequent generation wireless LAN standards into versions. 11be has a value of 000b. The UL/DL field identifies whether the PPDU is an uplink/downlink PPDU. BSS color indicates an identifier for each BSS defined in 11ax, and has a value of 6 bits or more. TXOP indicates transmit opportunity duration transmitted in a MAC header, wherein, by adding the TXOP to a PHY header, the PPDU may infer a length of the TXOP included therein without having to decode an MPDU, and the TXOP has a value of 7 bits or more.

The VD field is signaling information useful only for an 11be version of the PPDU, and may include a field commonly used in any PPDU format, such as PPDU format and BW, and a field defined differently for each PPDU format. The PPDU format is a classifier that classifies EHT single user (SU), EHT multiple user (MU), EHT trigger-based (TB), EHT extended range (ER) PPDU, etc. The BW field signals five basic PPDU BW options (BW, which is expressible in the form of an exponential power of 20*2, may be referred to as basic BW) of 20, 40, 80, 160 (80+80), and 320 (160+160) MHz and various remaining PPDU BWs configured via preamble puncturing. After being signaled at 320 MHz, signaling may be performed in a form in which some 80 MHz is punctured. A punctured and modified channel type may be signaled directly in the BW field, or may be signaled using the BW field with a field (e.g., a field within the EHT-SIG field) appearing after the BW field. If the BW field is configured to 3 bits, a total of 8 BW signaling may be performed, and therefore only up to 3 signaling may be performed in a puncturing mode. If the BW field is configured to 4 bits, a total of 16 BW signaling may be performed, and therefore up to 11 signaling may be performed in the puncturing mode.

A field located after the BW field varies depending on the type and format of the PPDU, an MU PPDU and an SU PPDU may be signaled in the same PPDU format, a field for classification between the MU PPDU and the SU PPDU may be located before an EHT-SIG field, and additional signaling may be performed for the same. Both the SU PPDU and the MU PPDU include the EHT-SIG field, but some fields that are not required in the SU PPDU may be compressed. Information on the field to which the compression has been applied may be omitted or may have a size smaller than a size of an original field included in the MU PPDU. For example, in a case of the SU PPDU, a common field of the EHT-SIG may be omitted or replaced, or the SU PPDU may have a different configuration in which a user specific field is replaced, reduced to one, or the like.

Alternatively, the SU PPDU may further include a compression field indicating whether compression is performed, and a part of field (e.g., RA fields, etc.) may be omitted according to a value of the compressed field.

If a part of the EHT-SIG field of the SU PPDU is compressed, information to be included in the compressed field may be signaled also in an uncompressed field (e.g., the common field, etc.). The MU PPDU corresponds to a PPDU format for concurrent reception by multiple users, and therefore the EHT-SIG field is required to be transmitted subsequently to the U-SIG field, and the amount of signaled information may vary. That is, a plurality of MU PPDUs are transmitted to a plurality of STAs, so that the respective STAs should recognize locations of RUs, at which the MU PPDUs are transmitted, the STAs to which the RUs have been allocated respectively, and whether the transmitted MU PPDUs have been transmitted to the STAs themselves. Therefore, an AP should transmit information described above, by including the same in the EHT-SIG field. To this end, information for efficient transmission of the EHT-SIG field is signaled in the U-SIG field, and this may correspond to an MCS that is a modulation method and/or the number of symbols in the EHT-SIG field. The EHT-SIG field may include information on a size and location of an RU allocated to each user.

In the case of the SU PPDU, a plurality of RUs may be allocated to an STA, and the plurality of RUs may be continuous or discontinuous. If the RUs allocated to the STA are discontinuous, the STA should recognize a punctured RU in the middle in order to efficiently receive the SU PPDU. Accordingly, the AP may transmit the SU PPDU including information (e.g., a puncturing pattern of the RUs, etc.) of punctured RUs among the RUs allocated to the STA. That is, in the case of the SU PPDU, a puncturing mode field, which includes information indicating, in a bitmap format, etc., a puncturing pattern and whether the puncturing mode is applied, may be included in the EHT-SIG field, and the puncturing mode field may signal a discontinuous channel type appearing within a bandwidth.

The signaled discontinuous channel type is limited, and indicates discontinuous channel information and BW of the SU PPDU in combination with a value of the BW field. For example, the SU PPDU is a PPDU transmitted only to a single terminal, so that the STA may recognize a bandwidth allocated to itself via the BW field included in the PPDU, and the SU PPDU may recognize a punctured resource in the allocated bandwidth via the puncturing mode field of the EHT-SIG field or the U-SIG field included in the PPDU. In this case, the terminal may receive the PPDU in resource units remaining after excluding a specific channel of the punctured resource unit. The plurality of RUs allocated to the STA may be configured by different frequency bands or tones.

Only a limited discontinuous channel type is signaled in order to reduce signaling overhead of the SU PPDU. Puncturing may be performed for each 20 MHz sub-channel, so that if puncturing is performed for BW having a large number of 20 MHz sub-channels, such as 80, 160, and 320 MHz, a discontinuous channel (if puncturing of only edge 20 MHz is considered to be discontinuous) type should be signaled in the case of 320 MHz by expressing whether each of 15 20 MHz sub-channels remaining after excluding a primary channel is used. As such, allocating 15 bits to signal a discontinuous channel type of single user transmission may act as excessively large signaling overhead in consideration of a low transmission rate of a signaling part.

The present invention proposes a technique for signaling a discontinuous channel type of an SU PPDU, and illustrates a discontinuous channel type determined according to the proposed technique. The present invention also proposes a technique for signaling each of puncturing types of primary 160 MHz and secondary 160 MHz in a 320 MHz BW configuration of an SU PPDU.

An embodiment of the present invention proposes a technique for differently configuring a PPDU indicated by preamble puncturing BW values according to a PPDU format signaled in a PPDU format field. It is assumed that a BW field is 4 bits, and in a case of an EHT SU PPDU or a TB PPDU, EHT-SIG-A of 1 symbol may be additionally signaled after U-SIG, or EHT-SIG-A may not be signaled at all, so that, in consideration of this, it is necessary to completely signal up to 11 puncturing modes via only the BW field of U-SIG. However, in a case of an EHT MU PPDU, EHT-SIG-B is additionally signaled after U-SIG, so that up to 11 puncturing modes may be signaled in a method different from that of the SU PPDU. In a case of an EHT ER PPDU, a BW field may be configured to 1 bit to signal whether the EHT ER PPDU is a PPDU using a 20 MHz or 10 MHz band.

FIG. 7(f) illustrates a configuration of a format-specific field of a VD field when the EHT MU PPDU is indicated in the PPDU format field of U-SIG. In the case of the MU PPDU, SIG-B, which is a signaling field for concurrent reception by multiple users, is essentially required, and SIG-B may be transmitted without separate SIG-A after U-SIG. To this end, information for decoding of SIG-B should be signaled in U-SIG. These fields include SIG-B MCS, SIG-B DCM, Number of SIG-B Symbols, SIG-B Compression, and Number of EHT-LTF Symbols.

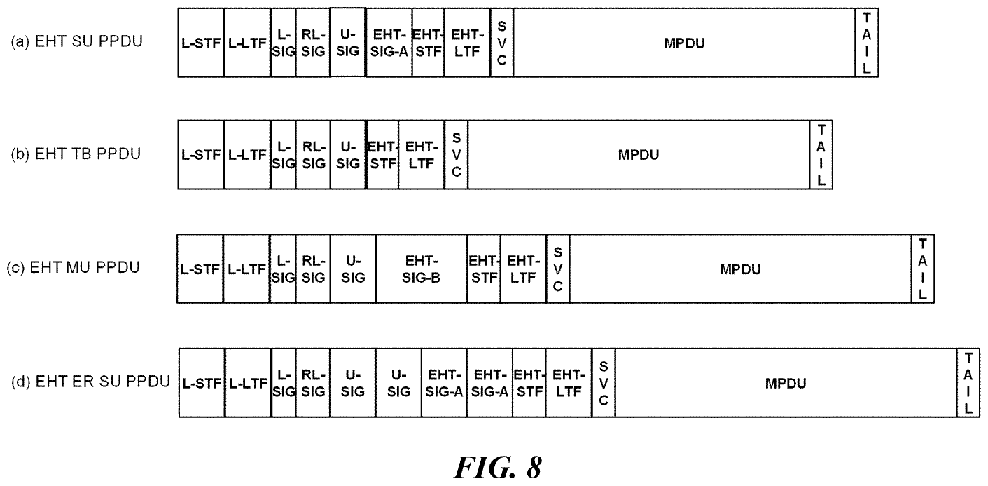

FIG. 8 illustrates an example of various extremely high throughput (EHT) physical protocol data unit (PPDU) formats and a method for indicating the same according to an embodiment of the present invention.

Referring to FIG. 8, a PPDU may include a preamble and a data part, and an EHT PPDU format, that is a PPDU type, may be classified according to a U-SIG field included in the preamble. Specifically, based on a PPDU format field included in the U-SIG field, whether the format of the PPDU is an EHT PPDU may be indicated.

FIG. 8(a) shows an example of an EHT SU PPDU format for a single STA. An EHT SU PPDU is a PPDU used for single user (SU) transmission between an AP and a single STA, and an EHT-SIG-A field for additional signaling may be located after the U-SIG field.

FIG. 8(b) shows an example of an EHT trigger-based PPDU format which corresponds to an EHT PPDU transmitted based on a trigger frame. An EHT Trigger-based PPDU is an EHT PPDU transmitted based on a trigger frame and is an uplink PPDU used for a response to the trigger frame. Unlike in the EHT SU PPDU, an EHT-SIG-A field is not located after a U-SIG field in the EHT PPDU.

FIG. 8(c) shows an example of an EHT MU PPDU format which corresponds to an EHT PPDU for multiple users. An EHT MU PPDU is a PPDU used to transmit the PPDU to one or more STAs. In the EHT MU PPDU format, an HE-SIG-B field may be located after a U-SIG field.

FIG. 8(d) shows an example of an EHT ER SU PPDU format used for single user transmission with an STA in an extended range. An EHT ER SU PPDU may be used for single user transmission with an STA of a wider range compared to the EHT SU PPDU described in FIG. 8(a), and a U-SIG field may be repeatedly located on a time axis.

The EHT MU PPDU described in FIG. 8(c) may be used by an AP to perform downlink transmission to a plurality of STAs. Here, the EHT MU PPDU may include scheduling information so that the plurality of STAs may concurrently receive the PPDU transmitted from the AP. The EHT MU PPDU may transfer, to the STAs, AID information of a transmitter and/or a receiver of the PPDU transmitted via a user specific field of EHT-SIG-B. Accordingly, the plurality of terminals having received the EHT MU PPDU may perform a spatial reuse operation based on the AID information of the user specific field included in a preamble of the received PPDU.

Specifically, a resource unit allocation (RA) field of the HE-SIG-B field included in the HE MU PPDU may include information on a configuration of a resource unit (e.g., a division form of the resource unit) in a specific bandwidth (e.g., 20 MHz, etc.) of a frequency axis. That is, the RA field may indicate configurations of resource units segmented in a bandwidth for transmission of the HE MU PPDU, in order for the STA to receive the PPDU. Information on the STA allocated (or designated) to each segmented resource unit may be included in the user specific field of EHT-SIG-B so as to be transmitted to the STA. That is, the user specific field may include one or more user fields corresponding to the respective segmented resource units.

For example, a user field corresponding to at least one resource unit used for data transmission among the plurality of segmented resource units may include an AID of a receiver or a transmitter, and a user field corresponding to the remaining resource unit(s) which is not used for data transmission may include a preconfigured null STA ID.

For convenience of description, in this specification, a frame or a MAC frame may be used interchangeably with an MPDU.

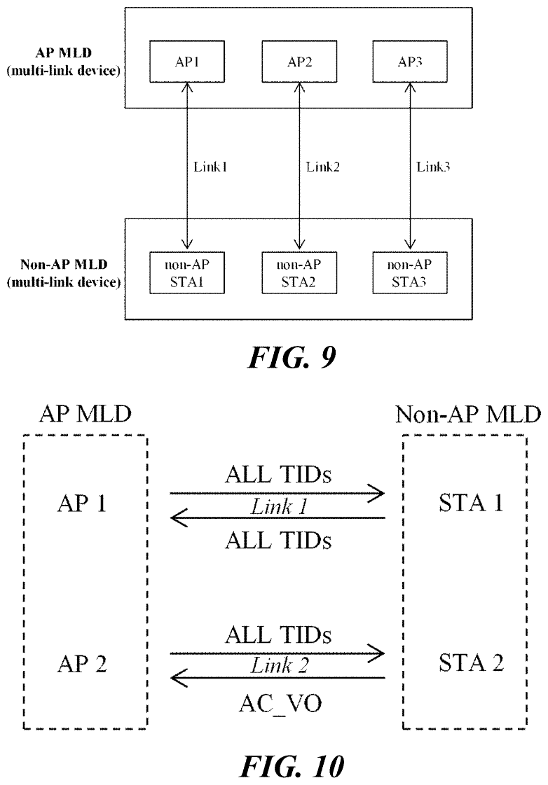

When one wireless communication device communicates by using a plurality of links, the communication efficiency of the wireless communication device may be increased. In this case, the link may be a physical path, and may consist of one wireless medium that may be used to deliver a MAC service data unit (MSDU). For example, in a case where frequency band of one of the links is in use by another wireless communication device, the wireless communication device may continue to perform communication through another link. As such, the wireless communication device may usefully use a plurality of channels. In addition, when the wireless communication device performs communication simultaneously by using a plurality of links, the overall throughput may be increased. However, in the existing wireless LAN, it has been stipulated that one wireless communication device uses one link. Therefore, a WLAN operation method for using a plurality of links is required. A wireless communication method of a wireless communication device using a plurality of links will be described through FIGS. 9 to 26. First, a specific form of a wireless communication device using a plurality of links will be described through FIG. 9.

FIG. 9 illustrates a multi-link device according to an embodiment of the disclosure.

A multi-link device (MLD) may be defined for a wireless communication method using the plurality of links described above. The multi-link device may represent a device having one or more affiliated stations. According to a specific embodiment, the multi-link device may represent a device having two or more affiliated stations. In addition, the multi-link device may exchange multi-link elements. The multi-link element includes information on one or more stations or one or more links. The multi-link element may include a multi-link setup element, which will be described later. In this case, the multi-link device may be a logical entity. Specifically, the multi-link device may have a plurality of affiliated stations. The multi-link device may be referred to as a multi-link logical entity (MLLE) or a multi-link entity (MLE). The multi-link device may have one medium access control (MAC) service access point (SAP) up to logical link control (LLC). The MLD may also have one MAC data service.

A plurality of stations included in the multi-link device may operate on a plurality of links. In addition, a plurality of stations included in the multi-link device may operate on a plurality of channels. Specifically, the plurality of stations included in the multi-link device may operate on a plurality of different links or on a plurality of different channels. For example, a plurality of stations included in the multi-link device may operate on a plurality of different channels of 2.4 GHz, 5 GHz, and 6 GHz.

The operation of the multi-link device may be referred to as a multi-link operation, an MLD operation, or a multi-band operation. In addition, when the station affiliated with the multi-link device is an AP, the multi-link device may be referred to as the AP MLD. In addition, when the station affiliated with the multi-link device is a non-AP station, the multi-link device may be referred to as a non-AP MLD.

FIG. 9 illustrates an operation in which a non-AP MLD and an AP-MLD communicate. Specifically, the non-AP MLD and the AP-MLD communicate by using three links, respectively. The AP MLD includes a first AP AP1, a second AP AP2, and a third AP AP3. The non-AP MLD includes a first non-AP STA (non-AP STA1), a second non-AP STA (non-AP STA2), and a third non-AP STA (non-AP STA3). The first AP AP1 and the first non-AP STA (non-AP STA1) communicate through a first link Link1. In addition, the second AP AP2 and the second non-AP STA (non-AP STA2) communicate through a second link Link2. In addition, the third AP AP3 and the third non-AP STA (non-AP STA3) communicate through a third link Link3.

The multi-link operation may include a multi-link setup operation. The multi-link setup may correspond to an association operation of the single link operation described above and may be preceded first for frame exchange in the multi-link. The multi-link device may obtain information necessary for the multi-link setup from a multi-link setup element. Specifically, the multi-link setup element may include capability information associated with the multi-link. In this case, the capability information may include information indicating whether any one of the plurality of devices included in the multi-link device performs the transmission and simultaneously, another device may perform the reception. In addition, the capability information may include information on the links available to each station included in the MLD. In addition, the capability information may include information on the channels available to each station included in the MLD.

The multi-link setup may be set up through negotiation between peer stations. Specifically, the multi-link setup may be performed through communication between stations without communication with the AP. In addition, the multi-link setup may be set up through any one link. For example, even if the first link to the third link are set through the multi-link, the multi-link setup may be performed through the first link.

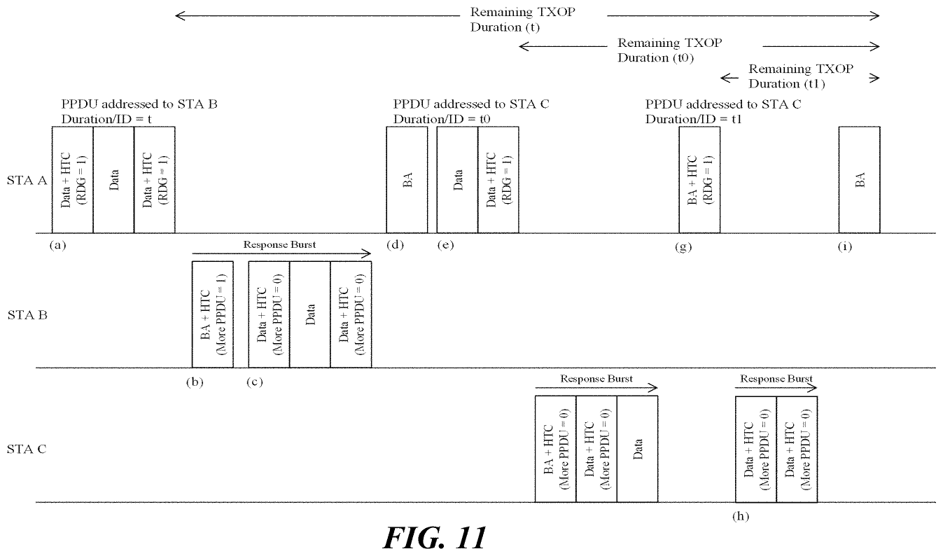

In addition, a mapping between a traffic identifier (TID) and a link may be set up. This will be described with reference to FIG. 10.

FIG. 10 is a diagram illustrating frame exchange performed between a non-AP multi-link device and an AP multi-link device in the case that TID-to-link mapping is configured according to an embodiment of the disclosure.

Specifically, frames corresponding to a TID of a particular value may only be interchanged through a pre-specified link. The mapping between the TID and the link may be set up with directional-based. For example, when a plurality of links is set up between the first multi-link device and the second multi-link device, the first multi-link device may be set to transmit a frame of the first TID to the plurality of first links, and the second multi-link device may be set to transmit a frame of the second TID to the first link. In addition, there may be a default setting for the mapping between the TID and the link. Specifically, in the absence of additional setup in the multi-link setup, the multi-link device may exchange frames corresponding to the TID at each link according to the default setting. In this case, the default setting may be that all the TIDs are exchanged in any one link.

A TID will be described in detail. The TID is an ID for classifying traffic and data in order to support quality of service (QoS). In addition, the TID may be used or allocated in a higher layer than a MAC layer. In addition, the TID may indicate a traffic category (TC) or a traffic stream (TS). In addition, the TID may be classified as 16 types. For example, the TID may be designated as one of the values in the range of 0 to 15. A TID value to be used may be differently designated according to an access policy and a channel access or medium access method. For example, in the case that enhanced distributed channel access (EDCA) or hybrid coordination function contention based channel access (HCAF) is used, the TID may be assigned with a value in the range of 0 to 7. In the case that the EDCA is used, the TID may indicate a user priority (UP). In this instance, the UP may be designated based on a TC or a TS. The UP may be allocated in a higher layer than MAC. In addition, in the case that HCF controlled channel access (HCCA) or SPCA is used, the TID may be assigned with a value in the range of 8 to 15. In the case that the HCCA or SPCA is used, the TID may indicate a TSID. In addition, in the case that the HEMM or the SEMM is used, the TID may be assigned with a value in the range of 8 to 15. In the case that the HEMM or SEMM is used, the TID may indicate a TSID.

A UP and an AC may be mapped. The AC may be a label for providing a QoS in EDCA. The AC may be a label for indicating an EDCA parameter set. An EDCA parameter or an EDCA parameter set may be a parameter used for EDCA channel contention. A QoS station may guarantee a QoS using the AC. In addition, the AC may include AC_BK, AC_BE, AC_VI, and AC_VO. The AC_BK, AC_BE, AC_VI, and AC_VO may indicate a background, a best effort, a video, and a voice, respectively. In addition, each of the AC_BK, AC_BE, AC_VI, and AC_VO may be classified into subordinate ACs. For example, the AC_VI may be subdivided into AC_VI primary and AC_VI alternate. In addition, the AC_VO may be subdivided into AC_VO primary and AC_VO alternate. In addition, a UP or a TID may be mapped to an AC. For example, a UP or TID having a value of 1, 2, 0, 3, 4, 5, 6, and 7 may be mapped to AC_BK, AC_BK, AC_BE, AC_BE, AC_VI, AC_VI, AC_VO, and AC_VO, respectively. In addition, a UP or TID having a value of 1, 2, 0, 3, 4, 5, 6, and 7 may be mapped to AC_BK, AC_BK, AC_BE, AC_BE, AC_VI alternate, AC_VI primary, AC_VO primary, and AC_VO alternate, respectively. In addition, a UP or TID having a value of 1, 2, 0, 3, 4, 5, 6, and 7 may sequentially have a high priority. That is, 1 denotes a low priority and 7 denotes a high priority. Therefore, AC_BK, AC_BE, AC_VI, and AC_VO may have high priorities, sequentially. In addition, AC_BK, AC_BE, AC_VI, and AC_VO may correspond to an AC index (ACI) 0, 1, 2, and 3, respectively. Due to such features of a TID, a mapping between a TID and a link may indicate a mapping between an AC and a link. In addition, a mapping between a link and an AC may indicate a mapping between a TID and a link.

As described above, a TID may be mapped to each of a plurality of links. Mapping may be designating a link in which traffic corresponding to a predetermined TID or AC is capable of being exchanged. In addition, a TID or AC that is transmittable for each transmission direction in a link may be designated. As described above, there may be a default configuration for a mapping between a TID and a link. Specifically, in the case that an additional configuration does not exist for a multi-link configuration, a multi-link device may exchange a frame corresponding to a TID in each link according to the default configuration. In this instance, the default configuration may be exchanging all TIDs in any one link. Any TID or AC at any point in time may be always mapped to at least any one link. A management frame and a control frame may be transmitted in all links.

In the case that a link is mapped to a TID or an AC, a frame may be transmitted based on the TID or AC mapped to the corresponding link in the corresponding link. Specifically, in the case that a link is mapped to a TID or an AC, only a frame corresponding to the TID or AC mapped to the corresponding link may be transmitted in the corresponding link. Therefore, in the case that a link is mapped to a TID or an AC, a frame that does not correspond to the TID or AC mapped to the corresponding link may not be transmitted in the corresponding link. In the case that a link is mapped to a TID or an AC, an ACK may also be transmitted based on the link to which the TID or the AC is mapped. For example, a block ACK agreement may be determined based on a mapping between a TID and a link. According to another embodiment, a mapping between a TID and a link may be determined based on a block ACK agreement. Particularly, a block ACK agreement may be set for a TID mapped to a predetermined link.

In the embodiment of FIG. 10, an AP multi-link device may include a first AP (AP1) and a second AP (AP2). A non-AP multi-link device may include a first station (STA1) and a second station (STA2). The first AP (AP 1) and the first station (STA 1) may be associated in a first link (Link 1), and the second AP (AP 2) and the second station (STA 2) may be associated in a second link (Link 2). All TIDs are mapped to the first link (Link 1) and AC_VO or a TID corresponding to the AC_VO is mapped to the second link (Link 2). In this instance, all the TIDs may be exchanged in the first link (Link 1), and the TID corresponding to AC_VO may be exchanged in the second link (Link 2). In addition, exchange of data that does not correspond to AC_VO may not be allowed in the second link (Link 2).

QoS may be guaranteed via the above-described mapping between a TID and a link. Specifically, an AC or TID having a high priority may be mapped to a link in which a relatively small number of stations operate or a link having a good channel condition. In addition, via the above-described mapping between a TID and a link, a station may be enabled to maintain a power-saving state during a long period of time.

FIG. 11 is a diagram illustrating frame exchange performed based on a reverse direction (RD) protocol according to an embodiment of the disclosure.

A frame may be exchanged based on a reverse direction protocol according to an embodiment of the disclosure. Specifically, a station that is a transmit opportunity (TXOP) holder may be allowed to transmit a frame to a responder, and a responder may be allowed to transmit a frame to a station that is a TXOP holder. In the case that a station that is not a TXOP holder receives RD grant (RDG) from a station that is a TXOP holder, the station that is not a TXOP holder may transmit a frame to the station that is a TXOP holder in a corresponding TXOP. That is, the station that receives the RDG may transmit a frame to the station that is a TXOP holder, without separately performing a contention-based channel access or backoff procedure. In this instance, the station that transmits the RDG is referred to as an RD initiator, and the station that receives the RDG is referred to as an RD responder. In addition, a process in which a frame is exchanged according to an RD protocol is referred to as RD exchange or an RD exchange sequence. An HT station, a VHT station, an HE station, an EHT station, a DMG station, and a Sub 1 GHz (S1G) station may support RD exchange.

A station may signal whether the station is capable of operating as an RD responder. Specifically, using a subfield of a HT extended capabilities field of an HE capabilities element, a station may signal whether the station is capable of operating as an RD responder. In this instance, the subfield may be referred to as an RD responder field. According to another detailed embodiment, using a 6 GHz cand capabilities element or a subfield of the 6 GHz band capabilities element, a station may signal whether the station is capable of operating as an RD responder. In the case that a station signals that the station is incapable of operating as an RD responder, transmission of RD grant to the station may not be allowed.

The station may use at least one of an RDG/More PPDU subfield and an AC constraint subfield, so as to perform signaling of information associated with RD exchange. In this instance, the RDG/More PPDU subfield and the AC constraint subfield may be included in an HTC field. The HTC field may be a high throughput control field. In addition, a frame including an HTC field may be referred to as a +HTC frame. In addition, an MPDU corresponding to a frame including an HTC field may be referred to as a +HTC MPDU. In addition, a CAS control subfield may include at least any one of an RDG/More PPDU subfield and an AC Constraint subfield.

RD exchange may be performed as follows.

An RD initiator may transmit a PPDU including an RDG to an RD responder. In this instance, the RD initiator may be a TXOP holder or a service period (SP) source. Whether an RDG is included may be signaled via the above-described RDG/More PPDU subfield. In the case that the value of an RDG/More PPDU subfield is 1, the RDG/More PPDU subfield may indicate that a PPDU including the RDG/More PPDU subfield includes an RDG. In the case that the value of an RDG/More PPDU subfield is 0, the RDG/More PPDU subfield may indicate that a PPDU including the RDG/More PPDU subfield does not include an RDG.

A station that receives an RDG may transmit a PPDU immediately after a PPDU including the RDG. That is, the station that receives the RDG may transmit a PPDU without separately performing contention-based channel access. In this instance, the interval between the PPDU including the RDG and the PPDU transmitted by the station that receives the RDG may be a short interframe space (SIFS) or a reduced interframe space (RIFS). In the specification, the term, ‘immediately after’ or ‘immediately’ may indicate a predetermined time interval. In this instance, the predetermined time interval may be an SIFS or an RIFS.

In the embodiments, a station that receives an RDG may transmit a PPDU to an RD initiator. That is, the PPDU transmitted by the station that receives the RDG may include a frame of which an intended receiver is the RD initiator. In addition, the station that receives the RDG may transmit a plurality of PPDUs. One or more PPDUs that the station that receives the RDG transmits after receiving a PPDU including the RDG may be referred to as an RD response or an RD response burst. In addition, the station that transmits the PPDU after receiving the RDG, that is, the station that transmits an RD response or an RD response may be referred to as an RD responder. As described above, the RD responder may successively transmit a plurality of PPDUs after receiving RDG. The RD responder may transmit a PPDU immediately after transmitting a single PPDU. In this instance, the RD responder may signal whether a PPDU is additionally transmitted immediately after a PPDU including a frame in the frame included in the PPDU. That is, the RD responder may signal whether a PPDU is additionally transmitted at an interval of SIFS or RIFS from the PPDU including the frame in the frame included in the PPDU. In this instance, the above-described RDG/More PPDU subfield may be used. Specifically, an RDG/More PPDU subfield that the RD initiator transmits may indicate an RDG, and an RDG/More PPDU subfield that the RD responder transmits may indicate whether a PPDU is additionally transmitted after a PPDU including an RDG/More PPDU. In addition, an RD response may include a maximum of a single immediate BlockACK frame or an ACK frame.

The RD initiator that receives an RD response may transmit an acknowledgment (ACK) to the RD responder. Specifically, the RD initiator may transmit an ACK to the RD responder immediately after receiving the RD response.

A plurality of RD exchange sequences may be included in a single TXOP or SP. In this instance, the plurality of RD exchange sequences may have the same RD initiator and may have different RD responders. In the embodiments, one RD responder may join a plurality of RD exchange sequences.

The RD responder may transmit a PPDU to be transmitted to a plurality of stations as an RD response. For example, in the case that the RD responder is a VHT AP, an RD response may include a VHT MU PPDU. In the case that the RD responder is an HE AP, an RD response may include an HE MU PPDU. In the case that the RD responder is an EHT AP, an RD response may include an EHT MU PPDU. In addition, the RD responder may transmit an RD response including a trigger frame. In this instance, the trigger frame may be restricted to a trigger frame that triggers an RD initiator to perform transmission. In the specification, the trigger frame may be a frame including a triggered response scheduling (TRS) field in addition to a trigger frame. A station that receives a trigger frame may transmit a trigger based (TB) PPDU as a response to a PPDU including the trigger frame. In this instance, the interval between the PPDU including the trigger frame and the TB PPDU may be an SIFS.

An AC or TID of a frame that the RD responder is capable of transmitting via an RD response may be restricted. In this instance, the RD initiator may signal whether an AC or TID of a frame that the RD responder is capable of transmitting via an RD response or an RD response burst is restricted. Specifically, the RD initiator may use an AC constraint subfield so as to signal whether an AC or TID of a frame that the RD responder is capable of transmitting via an RD response is restricted. In addition, in the case that the RD initiator obtains a TXOP via enhanced distributed channel access (EDCA) channel access, an AC or a TID of a frame that the RD responder is capable of transmitting via an RD response may be restricted. The RD initiator may not be allowed to request, from the RD responder, a frame other than a frame for an acknowledgement (ACK). Therefore, the RD initiator may not request, from the RD responder, a frame other than a frame for an acknowledgement (ACK). In this instance, the frame for an acknowledgement (ACK) may include at least one of an ACK frame, a compressed BlockAck frame, an extended compressed block frame, and a multi-STA BlockAck frame.

In the case that the RD responder signals that an additional PPDU is not to be transmitted, the RD initiator may transmit a PPDU immediately after an RD response. Specifically, in the case that the RD initiator receives a frame that may happen to include an HT control field from the RD responder, and the corresponding frame does not include a HT control field, the RD initiator may transmit a PPDU immediately after an RD response. According to another detailed embodiment, in the case that the RD initiator receives a frame that requests an immediate response from the RD responder, the RD initiator may transmit a PPDU immediately after an RD response.

In addition, in the case that the RD initiator does not receive an RD response in response to a PPDU including an RDG, the RD initiator may transmit a PPDU. Specifically, in the case that the RD initiator does not receive a response to the PPDU including the RDG within a predetermined period of time, the RD initiator may transmit a PPDU the predetermined period of time after the PPDU including the RDG. Specifically, the RD initiator may transmit a PPDU after a PIFS elapses from the point in time at which the PPDU including the RDG is transmitted. In addition, the RD initiator performs channel sensing before transmitting a PPDU, and may transmit a PPDU only when a channel is idle. This may be a part of a recovery operation of the RD initiator.

The RD responder may perform RD responding under the following conditions.

In addition, when the RD responder transmits an RD response, the RD responder may transmit an RD response irrespective of a configured network allocation vector (NAV).

In addition, the RD responder may perform RD responding within a TXOP or SP that the RD initiator obtains. The RD responder may obtain the duration of a TXOP or the duration of an SP from a MAC header of a frame included in the PPDU including the RDG. Specifically, the RD responder may obtain the duration of a TXOP or the duration of an SP from a duration/ID field of the MAC header of the frame included in the PPDU including the RDG.

In addition, a frame that the RD responder is capable of transmitting as an RD response may be restricted. Specifically, the frame that the RD responder is capable of transmitting as an RD response may be restricted to a frame for an acknowledgement (ACK), a QoS data frame, a QoS null frame, a management frame, and a basic trigger frame. In this instance, the frame for an acknowledgement (ACK) may include at least one of an ACK frame, a compressed BlockAck frame, an extended compressed block frame, and a multi-STA BlockAck frame.

In addition, an intended receiver of at least one frame included in an RD response may be restricted to the RD initiator. The intended receiver of the frame may be indicated by a MAC address. Specifically, a station corresponding to the MAC address indicated by an Address 1 field of the frame may be the intended receiver of the frame. According to another detailed embodiment, a station that a trigger frame triggers to perform transmission may be an intended receiver of the trigger frame.

In addition, when the RD responder transmits an RD response, the RD responder may transmit only a PPDU having a channel width that is narrower than or equal to a channel width of a PPDU including an RDG. In this instance, based on the value of CH_BANDWIDTH of RXVECTOR obtained when receiving the PPDU including the RDG, the RD responder may determine the channel width of the PPDU including the RDG.

In the case that the PPDU including the RDG requests an immediate block ACK response, the RD responder may include a BlockAck frame in a first PPDU of an RD response. As described above, in the case that the RD responder transmits a plurality of PPDUs as an RD response, the RD responder may signal that an additional PPDU is to be transmitted in a PPDU that is not the last PPDU of the RD response. Specifically, the RD responder may set the value of an RDG/More PPDU field of a PPDU that is not the last PPDU of the RD response, so as to indicate that an additional PPDU is to be transmitted. In addition, the RD responder may set the value of an RDG/More PPDU field of a PPDU that is not the last PPDU of the RD response, so as to indicate that an additional PPDU is not to be transmitted. In this instance, in the case that the value of the RDG/More PPDU is 1, this indicates that an additional PPDU is to be transmitted. In addition, in the case that the value of the RDG/More PPDU field is 0, this indicates that an additional PPDU is not to be transmitted. In addition, the RD responder may not be allowed to transmit an additional PPDU after transmitting a PPDU including a frame that requests an immediate response. Therefore, when transmitting a PPDU including a frame that requests a response, the RD responder may signal that an additional PPDU is not to be transmitted. In addition, after the RD responder signals that an additional PPDU is not to be transmitted, the RD responder may not transmit an additional PPDU as an RD response.

In the case that the RD responder transmits a trigger frame, the RD responder may configure the field of the trigger frame to indicate that channel sensing is not needed when a response to the trigger frame is provided. Specifically, the RD responder may set a CS required field of the trigger frame to 1. In this instance, the trigger frame may be a basic trigger frame.

As described above, a TID or AC of a frame to be included in a PPDU that the RD responder transmits as an RD response may be restricted. In the case that the RD initiator signals that an AC or TID of a frame that the RD responder is capable of transmitting is restricted, the RD responder may include, in a PPDU of an RD response, a frame corresponding to an AC that is the same as an AC of a frame including an RDG. Specifically, in the case that the RD initiator sets an RDG/More subfield to 1 and the value of an AC constraint subfield to 1, the RD responder may include, in a PPDU of an RD response, a frame corresponding to an AC that is the same as the AC of the frame including the RDG. In addition, in the case that the RD initiator signals that an AC or TID of a frame that the RD responder is capable of transmitting is restricted, the RD responder may set a preferred AC subfield of a trigger frame included in an RD response to indicate an AC that is the same as the AC of the frame including the RDG. The preferred AC subfield may indicate a recommended AC of an MPDU included in a PPDU to be transmitted in response to a frame including the preferred AC subfield. Specifically, the preferred AC subfield may indicate an AC having the lowest priority among ACs recommended for the AC of the MPDU included in the PPDU to be transmitted as the response to the frame including the preferred AC subfield. As described above, a preferred AC subfield may be included in a trigger frame. Specifically, a preferred AC subfield may be included in a basic trigger frame.

In the embodiment of FIG. 11, a first station (STA A) may be an RD initiator. In addition, a second station (STA B) and a third station (STA C) may be RD responders. In the embodiment of FIG. 11, PPDU exchange is performed eight times during a TXOP.

In a first PPDU exchange (a), the first station (STA A) may transmit a PPDU including a QoS data frame of which an intended receiver is the second station (STA B). In this instance, an Ack policy field of the QoS data frame that indicates the rule for response to the data frame may be set to an implicit BlockAck request indicating that an immediate response using a BlockAck frame is requested. In addition, RDG/More PPDU subfields of two QoS data frames included in a PPDU indicate an RDG. In addition, a duration/ID field of the QoS data frame may indicate a duration of a remaining TXOP.

In a second PPDU exchange (b), the second station (STA B) may transmit, to the first station (STA A), a PPDU including a BlockAck frame that is a +HTC frame. The value of an RDG/More PPDU field of the BlockAck frame is set to 1, so as to signal that an additional PPDU is to be transmitted immediately after transmission of the PPDU including the BlockAck frame.

In a third PPDU exchange (c), the second station (STA B) may transmit a PPDU including a QoS data frame to the first station (STA A). In this instance, the second station (STA B) may set the value of an RDG/More PPDU subfield of the QoS data frame to 0, and may signal that an additional PPDU is not to be transmitted immediately after transmission of the PPDU including the BlockAck frame.

In a fourth PPDU exchange (d), the first station (STA A) may obtain control of a TXOP again. The first station (STA 1) may transmit a PPDU including a BlockAck frame with respect to the second station (STA B). In this instance, the BlockAck frame may include ACKs with respect to the QoS data frames transmitted in the second and third PPDU exchange processes.

In a fifth PPDU exchange (e), the first station (STA A) may transmit a PPDU including a QoS data frame of which an intended receiver is the third station (STA C). In this instance, an Ack Policy field of the QoS data frame may be set to an implicit BlockAck Request. In addition, the first station (STA A) may set RDG/More PPDU subfields of two QoS data frames included in a PPDU to 1, and may perform signaling of an RDG. In addition, a duration/ID field of the QoS data frame may indicate a duration of a remaining TXOP.

In a sixth PPDU exchange (f), the third station (STA C) may transmit, to the first station (STA A), a PPDU including a BlockAck frame that is a +HTC frame and a QoS data frame. In this instance, the third station (STA C) may set an Ack policy field of the QoS data frame to an implicit BlockAck Request. In addition, the third station (STA C) may set the value of an RDG/More PPDU subfield of the QoS data frame to 0, and may signal that an additional PPDU is not to be transmitted immediately after transmission of the PPDU including a BlockAck frame.

In a seventh PPDU exchange (g), the first station (STA A) may obtain control of a TXOP again. The first station (STA A) may transmit a PPDU including a BlockAck frame with respect to the third station (STA C). In this instance, the BlockAck frame may include an ACK with respect to the QoS data frame transmitted in the sixth PPDU exchange. The first station (STA A) may set an RDG/More PPDU subfield of the BlockAck frame included in the PPDU to 1, and perform signaling of an RDG.

In an eighth PPDU exchange (h), the third station (STA C) may transmit, to the first station (STA A), a PPDU including two QoS data frames that are +HTC frames. In this instance, the third station (STA C) may set an Ack policy field of the QoS data frame to an implicit BlockAck Request. In this instance, the third station (STA C) may set the value of an RDG/More PPDU subfield of the QoS data frame to 0, and may signal that an additional PPDU is not to be transmitted immediately after transmission of the PPDU including a BlockAck frame.

In a ninth PPDU exchange (i), the first station (STA A) transmits, to the third station (STA C), a PPDU including a BlockAcK frame including an ACK with respect to the QoS data frame transmitted in the eighth PPDU exchange.

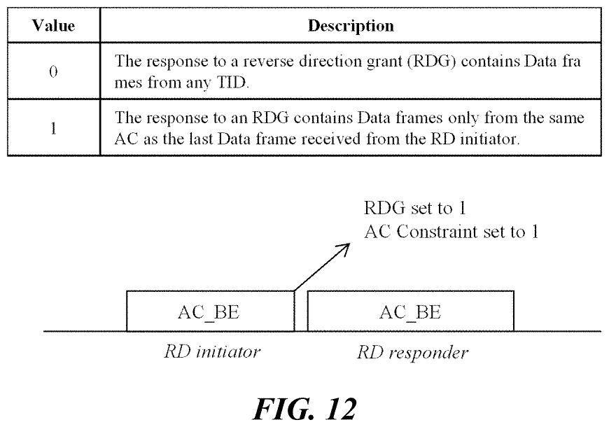

It has been described that an AC or TID of a frame to be included in a PPDU that an RD responder transmits as an RD response may be restricted in an RD protocol. This is based on the consideration of fairness with another station, since a TXOP holder may obtain a TXOP by using a channel access parameter corresponding to a predetermined AC. Constraint on an AC or TID of a frame to be included in a PPDU transmitted as an RD response will be described in detail with reference to FIG. 12. For ease of description, constraint on an AC or TID of a frame to be included in a PPDU transmitted as an RD response is referred to as AC constraint.

FIG. 12 is a diagram illustrating AC constraint signaling according to an embodiment of the disclosure.

The AC constraint signaling may indicate that a TID of a data frame to be included in a PPDU of a response to an RDG is not restricted. That is, the AC constraint signaling may signal that a data frame corresponding to any TID 15 capable of being included in the PPDU of the response to the RDG. In addition, the AC constraint signaling may indicate that an AC or TID of a frame to be included in the PPDU of the response to the RDG may be restricted. Specifically, the AC constraint signaling may indicate that the AC or TID of the frame to be included in the PPDU of the response to the RDG is restricted to an AC or TID value indicated by an RD initiator. According to another detailed embodiment, the AC constraint signaling may indicate that the AC or TID of the data frame to be included in the PPDU of the response to the RDG may be restricted to a value set based on a TID or AC of a frame received from the RD initiator. For example, the AC constraint signaling may indicate that the AC or TID of the data frame to be included in the PPDU of the response to the RDG is restricted to the TID or AC of the frame received from the RD initiator. In addition, the AC constraint signaling may indicate that an AC or TID of a frame to be included in the PPDU of the response to the RDG is restricted to a TID or AC having a priority that is higher than or equal to a priority of the TID or AC of the frame received from the RD initiator. In the embodiments, a frame received from the RD initiator may indicate a frame received last from the RD initiator. In another detailed embodiment, in the case that an RD responder receives a plurality of frames from the RD initiator, the frames received from the RD initiator may indicate a TID or AC having the lowest priority among the TIDs or ACs of the frames received from the RD initiator.

The RD responder may regard an AC of a management frame as a predetermined value. In this instance, the predetermined value may be AC_VO. In addition, based on a TID field of a BlockAckReq frame, the RD responder may determine an AC of the BlockAckReq frame, and based on a TID field of a BlockAck frame, the RD responder may determine an AC of the BlockAck frame. Specifically, the RD responder may determine the AC of the BlockAckReq frame based on an AC of a TID indicated by the TID field of BlockAckReq frame, and may determine the AC of the BlockAck frame based on an AC of a TID indicated by the TID field of the BlockACk frame. In this instance, the TID fields of the BlockACk frame and the BlockACkReq frame may indicate TIDs ACKed by ACKs. In addition, in the case that the RD initiator transmits a frame of which an AC is incapable of being determined, the RD initiator may not be allowed to configure RDG of the corresponding frame. Specifically, in the case that the RD initiator transmits a frame of which an AC is incapable of being determined, the RD initiator may not be allowed to set, to 1, an RDG/More PPDU field of the corresponding frame.

AC constraint signaling may be indicated by the above-described AC constraint subfield. Specifically, in the case that the value of the AC constraint subfield is 0, the AC constraint subfield may indicate that a TID of a data frame to be included in the PPDU of the response to the RDG is not restricted. In addition, in the case that the value of the AC constraint subfield is 1, the AC constraint subfield may indicate that a TID or AC of a frame to be included in the PPDU of the response to the RDG is restricted.

In the embodiment of FIG. 12, the RD initiator may transmit a QoS data frame corresponding to AC_BE to the RD responder via a PPDU including RDG. In this instance, the RD initiator may set the value of the AC constraint field to 1, and indicate that a TID or AC of a data frame to be included in a PPDU of an RD response is restricted. The TID or AC of the data frame to be included in the PPDU of the RD response is restricted, and thus, the RD responder may include a QoS data frame corresponding to AC_BE in the PPDU of the RD response.

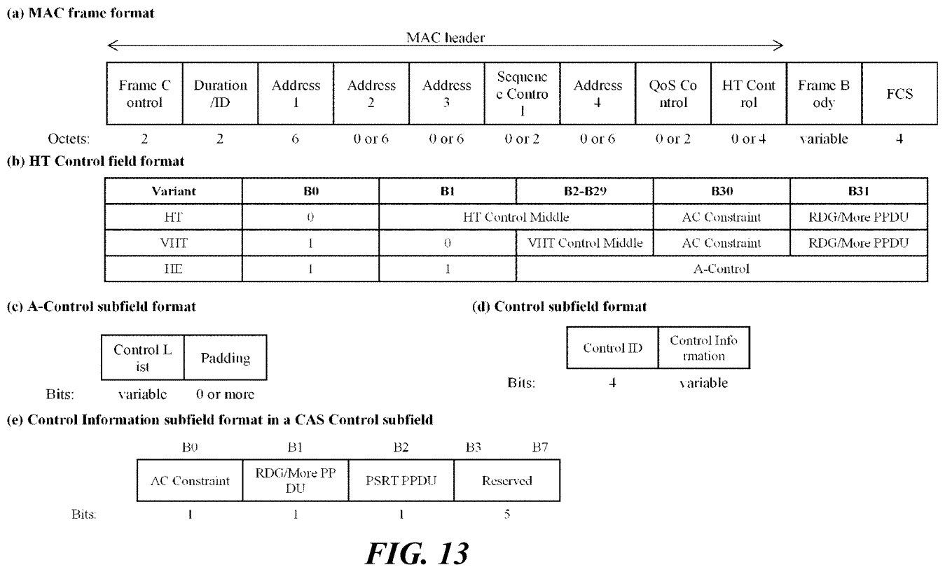

FIG. 13 is a diagram illustrating a format of a frame and a format of a signaling field of a frame according to an embodiment of the disclosure.

(a) of FIG. 13 illustrates the format of an MAC frame. A MAC frame may include a MAC header, a frame body, and an FCS. A MAC header may include at least any one of an RDG/More PPDU subfield and an AC Constraint subfield which have been described above.

Specifically, the MAC header may include a frame control field, a duration/ID field, a MAC address field, a sequence control field, a QoS control field, and an HT control field. The frame control field may include a type subfield and a subtype subfield. Each of the type subfield and the subtype subfield may indicate the type of a frame and the subtype of a frame, respectively. In addition, the frame control field may include a +HTC subfield, and the +HTC subfield may indicate whether a frame including the frame control field includes an HT control field. A duration/ID field may indicate a duration. In the case that a frame including a duration/ID field is not a PS-Poll frame, the duration/ID field indicates a duration. In addition, a station that receives a MAC frame may configure a NAV based on a duration indicated by a duration/ID field. The duration/ID field may indicate an ID, for example, an AID. In the case that a MAC frame including a duration/ID field is a PS-Poll frame, the duration/ID field may indicate an ID.

In addition, a MAC address field may include one or more address fields. An address field may indicate a MAC address. In addition, an address field may include at least one of a basic service set identifier (BSSID) field, a source address (SA) field, a destination address (DA) field, a transmitting STA address or transmitter address (TA) field, and a receiving STA address or receiver address (RA) field. In addition, a sequence control field may indicate a fragment number or a sequence number corresponding to a MAC frame that includes the sequence control field. In addition, a QoS control field may indicate at least any one of a TID of a MAC frame that includes the QoS control field, an Ack policy corresponding to a MAC frame that includes the QoS control field, a TXOP limit, a buffer status of a station that transmits a MAC frame including the QoS control field, and a queue size of a station that transmits a MAC frame including a QoS control field. In addition, the QoS control field may include at least any one of an RDG/More PPDU subfield and an AC constraint subfield which have been described above. For example, a QoS control field included in a DMG PPDU may include an RDG/More PPDU subfield and an AC constraint subfield which have been described above.

An HT control field may include at least any one of an RDG/More PPDU subfield and an AC constraint subfield which have been described above. An HT control field may be configured with 4 octets, that is, 32 bits.

A MAC header and fields included in the MAC header may have predetermined lengths.

A frame body field may include content of a MAC frame. For example, the frame body field may include information corresponding to a frame type and a subtype.

An FCS field may indicate a frame check sequence (FCS) of a MAC frame that includes an FCS field. The value of the FCS field may be an FCS obtained based on the values of the MAC header and the frame body field. A station that receives a MAC frame may determine, based on the value of a FCS field, whether a MAC frame is successfully received.

(b) of FIG. 13 illustrates the format of an HT control field. An HT control field may include at least any one of an AC constraint subfield and an RDG/More PPDU subfield.

For example, the HT control field may be configured with 32 bits (from B0 to B31). In this instance, B30 and B31 may be an AC constraint subfield and an RDG/More PPDU subfield, respectively. The format of an HT control field may be changed depending on the format of a PPDU that includes the HT control field. The above-described HT control field may be a HT variant included in an HT PPDU or a VHT variant included in a VHT PPDU. In addition, the format of the HT control field may be a HE variant included in a HE PPDU or an EHT variant included in an EHT PPDU. In this instance, the HE variant may indicate a variant of an HT control field included in a PPDU that is employed by the subsequent standard released after the 802.11ax standard. An HT control field may include signaling indicating what variant the HT control field belongs to. For example, some bits of the HT control field may indicate what variant the HT control field belongs to. In the case that the value of B0 is 0, B0 may indicate that the HT control field is an HT variant. In the case that the value of B0 is 1, B0 may indicate that the HT control field is a VHT variant, an HE variant, or an EHT variant. In the case that the value of B0 is 1 and the value of B1 is 0, B0 and B1 may indicate that the HT control field is a VHT variant. In the case that the value of B0 is 1 and the value of B1 is 1, B0 and B1 may indicate that the HT control field is a HE variant or an EHT variant. According to another detailed embodiment, in the case that the value of B0 is 1 and the value of B1 is 1, B0 and B1 may indicate that the HT control field is an HE variant, an EHT variant, or a variant of an HT control field included in a PPDU employed after the 802.11be standard. In addition, in the case that the HT control field is an HE variant, an EHT variant, or a variant of an HT control field included in a PPDU employed after the 802.11be standard, the HT control field may include an aggregated control (A)-control subfield. For example, B2 to B31 of the HT control field may be an A-control subfield. The A-control subfield may include control information.

(c) of FIG. 13 is a diagram illustrating the A-control subfield of FIG. 13B. The A-control subfield may include a control list subfield and a padding subfield. The control list subfield may include one or more pieces of control information. In addition, the control list subfield may include one or more control subfields. In addition, the A-control subfield may or may not include a padding subfield. For example, a length remaining after excluding a control list subfield from the predetermined length of the A-control subfield may be a padding subfield. In detailed embodiment, the padding subfield may be set to a predetermined value. Alternatively, the padding subfield may start with a predetermined value.

(d) of FIG. 13 is a diagram illustrating the format of the control subfield of FIG. 13C. The control subfield may include a control ID subfield and a control information subfield.

The control ID subfield may indicate which content is included in the control information subfield or which control information is included in a control subfield that includes the control ID subfield. In addition, a station may determine the length of the control information subfield based on the value of the control ID subfield. The length of the control ID subfield may be 4 bits. Information that the control subfield may include may include triggered response scheduling (TRS) control that has been described above. The control subfield may include TRS that is information triggering a station that receives the control subfield to perform transmission. The value of a control ID corresponding to a TRS may be 0. In addition, the control subfield may include information associated with an operating mode (OM). The value of a control ID corresponding to an OM may be 1. In addition, the control subfield may include information associated with link adaptation. The value of a control ID corresponding to link adaptation information may be 2. In addition, the control subfield may include information associated with a buffer. The information associated with a buffer may be a buffer status report (BSR). The value of a control ID corresponding to a BSR may be 3. In addition, the control subfield may include information associated with an uplink power headroom (UL power headroom). The information associated with UL power headroom may be a value indicating the amount of transmittable power that remains or may be a value used for power pre-correction. The value of a control ID corresponding to information related to UL power headroom may be 4. In addition, the control subfield may include signaling indicating the status of a subchannel. The signaling indicating the status of a subchannel may include a bandwidth query report (BQR). The value of a control ID corresponding to a BQR may be 5. For example, the BQR may indicate whether a subchannel is available. In addition, the control subfield may include information associated with a command and status (CAS). The value of a control ID corresponding to a CAS may be 6.

(e) of FIG. 13 is a diagram illustrating the format of a control information subfield in the case that a control subfield includes a CAS. According to an embodiment of the disclosure, an A-control subfield may include an AC constraint subfield and an RDG/More PPDU subfield. Specifically, in the case that the A-control subfield includes a CAS, a control information subfield corresponding to the CAS may include an AC constraint subfield and an RDG/More PPDU subfield. For example, a first bit and a second bit of the control information subfield corresponding to the CAS may be an AC constraint subfield and an RDG/More PPDU subfield, respectively. In addition, the CAS may include a PSRT PPDU subfield. The PSRT subfield may indicate whether a PPDU including the PSRT subfield is a parameterized spatial reuse transmission (PSRT) PPDU. In addition, the PSRT PPDU may be a PPDU transmitted via a parameterized spatial reuse (PSR) opportunity. In addition, in the case that the control subfield includes a CAS, the control information subfield may include a reserved field.

The AC constraint subfield and the RDG/More PPDU subfield described in FIG. 13 may be the AC constraint subfield and the RDG/More PPDU subfield which have been mentioned with reference to above-described drawings.

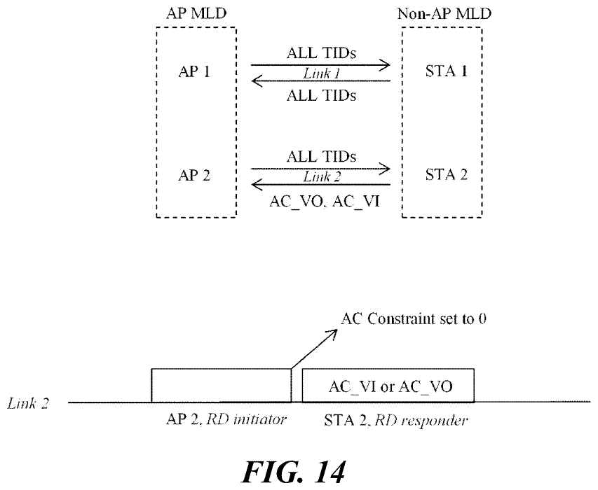

Even when RD exchange is performed, the above-described TID-to-link mapping may be applied. In this instance, AC constraint may be applied to RD exchange. Therefore, when RD exchange is performed in a link to which TID-to-link mapping is applied, the range of frames that an RD responder is capable of transmitting via an RD response may matter. This will be described with reference to FIGS. 14 to 20.

FIG. 14 is a diagram illustrating RD exchange performed, when AC constraint is not applied, in a link to which TID-to-link mapping is applied according to an embodiment of the disclosure.

In the case that RD exchange is performed in a link to which TID-to-link mapping is applied and AC constraint is not applied to RD exchange, an RD responder may perform RD responding based on a TID or AC mapped to the link. Specifically, in the case that RD exchange is performed in a link to which TID-to-link mapping is applied and AC constraint is not applied to the RD exchange, the RD responder is capable of transmitting, via an RD response, a frame that corresponds to any one of a TID or AC mapped to the link. In this instance, the RD responder may select any AC or TID among the TIDs or ACs mapped to the link, and may transmit a data frame corresponding to the selected AC or TID via the RD response. Specifically, the RD responder may include a data frame corresponding to the TID mapped to the link in a PPDU transmitted as a response to a PPDU including RDG, and may not include a data frame corresponding to the a TID that is not mapped to the link. That is, although AC constraint is not applied, the RD responder may not be allowed to transmit a frame corresponding to a TID or AC that is not the TID or AC mapped to the link.

According to another detailed embodiment, in the case that RD exchange is performed in a link to which TID-to-link mapping is applied and AC constraint is not applied to the RD exchange, the RD responder may be capable of transmitting, via an RD response, a data frame that corresponds to a TID or AC having a priority that is higher than or equal to the priority of the TID or AC mapped to the link. Specifically, in the case that RD exchange is performed in a link to which TID-to-link mapping is applied and AC constraint is not applied to the RD exchange, the RD responder may be capable of transmitting, via an RD response, a data frame that corresponds to a TID or AC having a priority that is higher than the lowest priority among the priorities of TIDs or ACs mapped to the link. Therefore, in the case that RD exchange is performed in a link to which TID-to-link mapping is applied and AC constraint is not applied to the RD exchange, the RD responder may be incapable of transmitting, via an RD response, a data frame that corresponds to a TID or AC having the lowest priority among the priorities of TIDs or ACs mapped to the link.

In the above-described embodiments, TID-to-link mapping may be TID-to-link mapping applied when an RD responder performs transmission. This is because TID-to-link mapping applied to an RD initiator is not applied to an RD responder. In addition, the embodiments may be applied when an RD responder performs transmission to a plurality of stations via an RD response.

In the embodiment of FIG. 14, an AP multi-link device may include a first AP (AP1) and a second AP (AP2). In addition, a non-AP multi-link device may include a first station (STA 1) and a second station (STA 2). The first AP (AP 1) and the first station (STA 1) may be associated in a first link (Link 1), and the second AP (AP 2) and the second station (STA 2) may be associated in a second link (Link 1). All TIDs may be mapped to the first link (Link 1). The second AP (AP 2) may be capable of transmitting all TIDs in a second link (link 2). However, in the case that the second station (STA 2) transmits a data frame in the second link (Link 2), the second station (STA 2) may be capable of transmitting a data frame corresponding to AC_VO and AC_VI in the second link (Link 2) according to TID-to-link mapping.

In the second link (Link 2), the second AP (AP 2) may transmit RDG to the second station. In this instance, the second AP (AP 2) may set the value of an AC constraint subfield to 0 and may signal that AC constraint is not applied. The second station (STA2) may transmit a data frame corresponding to AC_VI or AC_VO via an RD response. In addition, the second station (STA2) may be in capable of transmitting a data frame that does not correspond to AC_VI and AC_VO via an RD response.

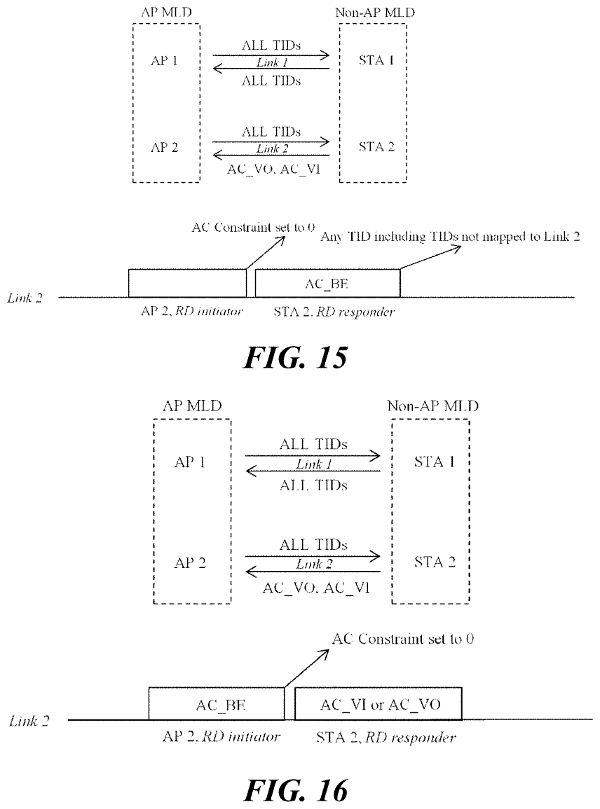

FIG. 15 is a diagram illustrating RD exchange performed, when AC constraint is not applied, in a link to which TID-to-link mapping is applied according to another embodiment of the disclosure.

In the case that RD exchange is performed in a link to which TID-to-link mapping is applied and AC constraint is not applied to the RD exchange, an RD responder may perform RD responding irrespective of TID-to-link mapping. Specifically, in the case that RD exchange is performed in a link to which TID-to-link mapping is applied and AC constraint is not applied to the RD exchange, the RD responder may be capable of transmitting, via an RD response, a data frame that corresponds to any TID irrespective of TID-to-link mapping. In a detailed embodiment, in the case that RD exchange is performed in a link to which TID-to-link mapping is applied and AC constraint is not applied to the RD exchange, the RD responder may be capable of transmitting, via an RD response, a data frame that corresponds to a TID or AC that is not mapped to the link.

In the above-described embodiments, TID-to-link mapping may be TID-to-link mapping applied when an RD responder performs transmission. This is because TID-to-link mapping applied to an RD initiator is not applied to an RD responder. In addition, the embodiments may also be applied when an RD responder performs transmission to a plurality of stations via an RD response.

In the embodiment of FIG. 15, an AP multi-link device may include a first AP (AP1) and a second AP (AP2). In addition, a non-AP multi-link device may include a first station (STA 1) and a second station (STA 2). The first AP (AP 1) and the first station (STA 1) may be associated in a first link (Link 1), and the second AP (AP 2) and the second station (STA 2) may be associated in a second link (Link 1). All TIDs may be mapped to the first link (Link 1). The second AP (AP 2) may be capable of transmitting all TIDs in the second link (Link 2). However, in the case that the second station (STA 2) transmits a data frame in the second link 2 (Link 2) according to TID-to-link mapping applied to the second link (Link 2), the second station (STA 2) may transmit a data frame corresponding to AC_VO and AC_VI in the second link (Link 2).

In the second link (Link 2), the second AP (AP 2) may transmit RDG to the second station. In this instance, the second AP (AP 2) may set the value of an AC constraint subfield to 0 and may signal that AC constraint is not applied. The second station (STA2) may be capable of transmitting, via an RD response, a data frame corresponding to any TID, irrespective of TID-to-link mapping applied to the second link (Link 2). Therefore, in an RD response, the second station (STA 2) may transmit a QoS data frame corresponding to AC_BE that is an AC not mapped to the second link (Link 2).

FIG. 16 is a diagram illustrating an example of not applying AC constraint when RD exchange is performed in a link to which TID-to-link mapping is applied according to another embodiment of the disclosure.

In the case that a TID or AC of a frame that an RD initiator transmits via a PPDU including RDG is not mapped to a link that an RD responder uses for RD responding, the RD initiator may not be allowed to apply AC constraint. That is, in the case that a TID or AC of a frame that the RD initiator transmits via a PPDU including RDG is not mapped to a link that the RD responder uses for RD responding, the RD initiator may not apply AC constraint. In this instance, the RD initiator may signal that AC constraint is not applied.

According to another detailed embodiment, in the case that a TID or AC having a higher priority than a priority of a TID or AC of a frame that the RD initiator transmits via a PPDU including RDG is not mapped to a link that the RD responder uses for RD responding, the RD initiator may not be allowed to apply AC constraint. That is, in the case that a TID or AC having a higher priority than a priority of a TID or AC of a frame that the RD initiator transmits via a PPDU including RDG is not mapped to a link that the RD responder uses for RD responding, the RD initiator may not apply AC constraint. In this instance, the RD initiator may signal that AC constraint is not applied.

In the above-described embodiments, a TID or AC of a frame that the RD initiator transmits via a PPDU including RDG may be a TID or AC having the lowest priority among TIDs or ACs of frames that the RD initiator transmits via PPDUs including RDG. According to another detailed embodiment, a TID or AC of a frame that the RD initiator transmits via a PPDU including RDG may be a TID or AC having the lowest priority among TIDs or ACs of frames that the RD responder receives from PPDUs including RDG. According to another detailed embodiment, a TID or AC of a frame that the RD initiator transmits via a PPDU including RDG may be a TID or AC of a frame received last among frames that the RD initiator transmits via PPDUs including RDG. According to another detailed embodiment, a TID or AC of a frame that the RD initiator transmits via a PPDU including RDG may be a TID or AC of a frame that the RD responder receives last via a PPDU including RDG.

In the above-described embodiments, TID-to-link mapping may be TID-to-link mapping applied when an RD responder performs transmission. TID-to-link mapping applied to an RD initiator is not applied to an RD responder. In addition, the embodiments may also be applied to the case in which an RD responder performs transmission to a plurality of stations via an RD response.

In the embodiment of FIG. 16, an AP multi-link device may include a first AP (AP1) and a second AP (AP2). A non-AP multi-link device may include a first station (STA 1) and a second station (STA 2). The first AP (AP 1) and the first station (STA 1) may be associated in a first link (Link 1), and the second AP (AP 2) and the second station (STA 2) may be associated in a second link (Link 1). All TIDs may be mapped to the first link (Link 1). The second AP (AP 2) may be capable of transmitting all TIDs in the second link (Link 2). However, in the case that the second station (STA 2) transmits a data frame in the second link 2 (Link 2), the second station (STA 2) may transmit a frame corresponding to AC_VO and AC_VI in the second link (Link 2) according to TID-to-link mapping.

In the second link (Link 2), the second AP (AP 2) may transmit RDG to the second station. In this instance, the second AP (AP 2) may set the value of an AC constraint subfield to 0 and may signal that AC constraint is not applied. This is because that the second AP (AP2) transmits a QoS data frame corresponding to AC_BE via a PPDU including RDG, and AC_BE is not mapped to the second link in which the second station (STA 2) is to perform transmission. The second station (STA 2) may perform RD responding according to any one of the embodiments which have been described with reference to FIGS. 14 and 15.

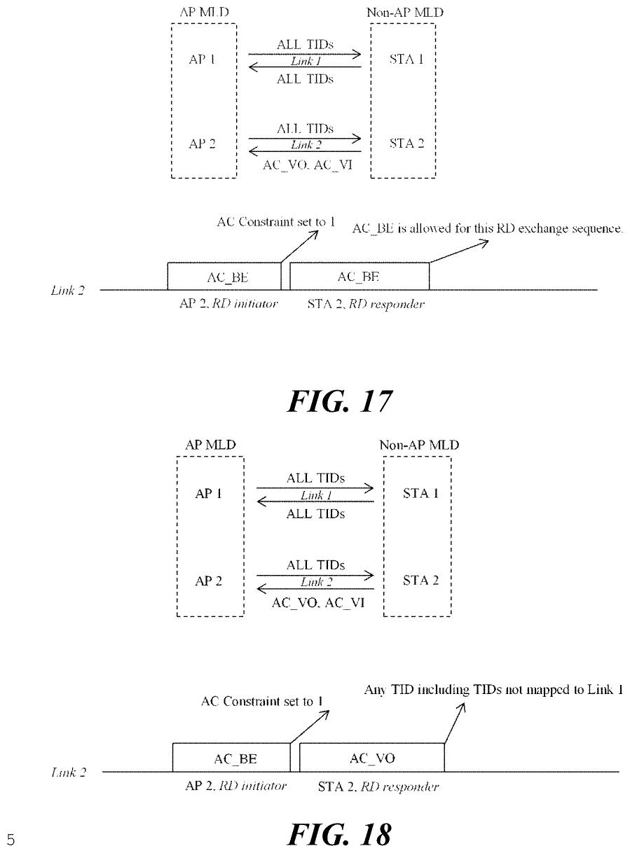

FIG. 17 is a diagram illustrating RD exchange performed, when AC constraint is applied, in a link to which TID-to-link mapping is applied according to another embodiment of the disclosure.

In the case that an RD initiator signals that an AC is restricted in RD responding, an RD responder may be allowed to transmit, via an RD response, a frame corresponding to a TID or AC that is not mapped to a link in which RD responding is performed. In this instance, based on a TID or AC of a frame received via a PPDU including RDG, the RD responder may determine a TID or AC of a frame that the RD responder transmits via an RD response. Specifically, the RD responder may determine a TID or AC of a frame that the RD responder transmits via an RD response, to be identical to a TID or AC of a frame received via a PPDU including RDG. According to another detailed embodiment, the RD responder may determine an AC or TID having a priority higher than or equal to a priority of a TID or AC of a frame received via a PPDU including RDG, as a TID or AC of a frame that the RD responder is to transmit via an RD response. A TID or AC of a frame received via a PPDU including RDG may be a TID or AC of a frame that is received last via a PPDU including RDG. In addition, as described in the above-described embodiments, exceptional transmission based on TID-to-link mapping may be allowed only when RD exchange, for which AC constraint has been signaled, is performed.

In the above-described embodiments, TID-to-link mapping may be TID-to-link mapping applied when an RD responder performs transmission. This is because that the TID-to-link mapping applied to an RD initiator is not applied to an RD responder. In addition, the embodiments may also be applied to the case in which an RD responder performs, via an RD response, transmission to a plurality of stations.

In the embodiment of FIG. 17, an AP multi-link device may include a first AP (AP1) and a second AP (AP2). A non-AP multi-link device may include a first station (STA 1) and a second station (STA 2). The first AP (AP 1) and the first station (STA 1) may be associated in a first link (Link 1), and the second AP (AP 2) and the second station (STA 2) may be associated in a second link (Link 1). All TIDs may be mapped to the first link (Link 1). The second AP (AP 2) may be capable of transmitting all TIDs in the second link (Link 2). However, the second station (STA 2) may transmit only a frame corresponding to AC_VO and AC_VI in the second link (Link 2) according to TID-to-link mapping applied to the second link (Link 2).

In the second link (Link 2), the second AP (AP 2) may transmit RDG to the second station. In this instance, the second AP (AP 2) may set the value of an AC constraint subfield to 1 and may signal that AC constraint is applied. In addition, the second AP (AP 2) may transmit a QoS data frame corresponding to AC_BE via a PPDU including RDG. Although AC_BE is not mapped to the second link (Link 2), the second station (STA 2) may transmit a frame corresponding to AC_BE via an RD response.

FIG. 18 is a diagram illustrating RD exchange performed, when AC constraint is applied, in a link to which TID-to-link mapping is applied according to another embodiment of the disclosure.

According to another embodiment, in the case that an RD initiator signals that an AC is restricted in RD responding, and TID-to-link mapping is applied to a link in which RD responding is performed, an RD responder may transmit any TID via an RD response. That is, in the case that the RD initiator signals that an AC is restricted in RD responding, and TID-to-link mapping is applied to the link in which RD responding is performed, the RD responder may transmit an RD response in the same manner as the embodiment described with reference to FIG. 15.

In the embodiment of FIG. 18, an AP multi-link device may include a first AP (AP1) and a second AP (AP2). A non-AP multi-link device may include a first station (STA 1) and a second station (STA 2). The first AP (AP 1) and the first station (STA 1) may be associated in a first link (Link 1), and the second AP (AP 2) and the second station (STA 2) may be associated in a second link (Link 1). All TIDs may be mapped to the first link (Link 1). The second AP (AP 2) may be capable of transmitting all TIDs in the second link (link 2). However, in the case that the second station (STA 2) transmits a data frame in the second link (Link 2), the second station (STA 2) may transmit a data frame corresponding to AC_VO and AC_VI in the second link (Link 2) according to TID-to-link mapping.

In the second link (Link 2), the second AP (AP 2) may transmit RDG to the second station. In this instance, the second AP (AP 2) may set the value of an AC constraint subfield to 1 and may signal that AC constraint is applied. In RD responding, the second station (STA 2) is capable of transmitting a data frame corresponding to any TID including a TID that does not correspond to an AC or TID mapped to the second link.

In the case that RD exchange is performed in a link to which TID-to-link mapping is applied and AC constraint is applied to RD exchange, the RD responder may perform RD responding based on a TID or AC mapped to the link. Specifically, in the case that RD exchange is performed in the link to which TID-to-link mapping is applied and AC constraint is applied to the RD exchange, the RD responder may transmit, via an RD response, a data frame corresponding to an AC or TID having a priority that is higher than or equal to a priority of an AC or TID of a frame received from the RD initiator, and corresponding to any one of a TID or AC mapped to the link. For ease of description, a PPDU transmitted as a response to a PPDU including RDG is referred to as an RD response PPDU. Specifically, when the RD responder transmits a data frame via RD responding, the RD responder may not include, in an RD response PPDU, a data frame that corresponds to a TID or AC having a priority lower than a priority of a TID or AC of a frame received from the RD initiator, or corresponds to a TID or AC that is not mapped to a link. In this instance, the RD responder may include, in the RD response PPDU that is a PPDU transmitted as a response to a PPDU including RDG, a data frame that corresponds to a TID or AC having a priority higher than or equal to a priority of a TID or AC of a frame received from the RD responder, and corresponds to a TID or AC mapped to a link.

The frame received from the RD initiator may be a frame that the RD responder receives last from the RD initiator. According to another detailed embodiment, in the case that the RD responder receives a plurality of frames from the RD initiator, the frame received from the RD initiator may indicate a TID or AC having the lowest priority among the TIDs or ACs of the frames received from the RD initiator. In this instance, the plurality of frames may be a plurality of frames included in a PPDU that the RD responder receives last from the RD initiator.

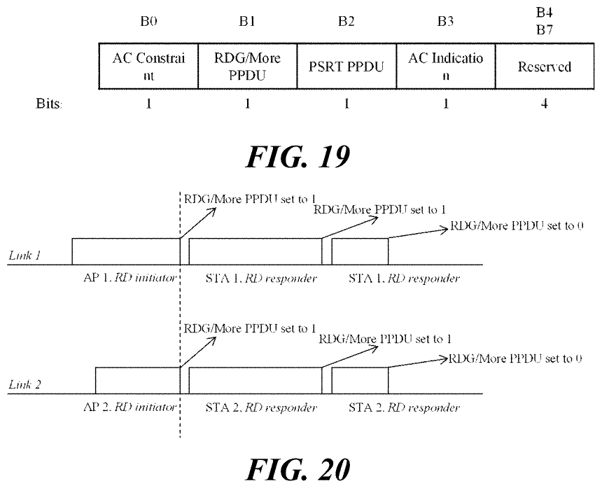

FIG. 19 is a diagram illustrating that an RD initiator signals information associated with AC constraint used in RD responding according to an embodiment of the disclosure.

An RD initiator may signal information associated with AC constraint applied to RD exchange. For ease of description, such signaling is referred to as AC constraint information signaling. An RD responder may determine, based on the AC constraint information signaling, an AC or TID of a frame to be transmitted in RD responding. The information associated with AC constraint applied to RD exchange may be information used in the embodiments which have been described with reference to FIGS. 11 to 18. For example, the information associated with AC constraint may indicate an AC constraint method of the embodiments that have been described with reference to FIGS. 11 to 18. For example, the AC constraint information signaling may indicate whether TID-to-link mapping is applied to RD responding. In the case that the AC constraint information signaling has a first value designated in advance and an AC constraint subfield indicates that a TID or AC is not restricted, the RD responder may transmit an RD response irrespective of TID-to-link mapping. In the case that the AC constraint information signaling has a second value designated in advance and the AC constraint subfield indicates that a TID or AC is not restricted, the RD responder may transmit an RD response according to TID-to-link mapping. Specifically, in the case that the AC constraint information signaling has the second value designated in advance and the AC constraint subfield indicates that a TID or AC is not restricted, the RD responder may perform RD responding only using a TID or AC mapped to a link in which RD responding is performed according to TID-to-link mapping.

In the case that the AC constraint subfield indicates that a TID or AC is restricted, the RD responder may determine, based on the AC constraint information signaling, whether to apply TID-to-link mapping to perform RD responding.

The AC constraint information signaling may be included in an A-control subfield. According to another detailed embodiment, the AC constraint information signaling may be included in a CAS. FIG. 19 is a diagram illustrating a control information subfield of a CAS according to an embodiment of the disclosure. In this instance, the control information subfield may include AC constraint information signaling (AC indication subfield). According to another detailed embodiment, the AC constraint information signaling may be included in the reserved field of the control information subfield that has been described with reference to FIG. 13E.

FIG. 20 is a diagram illustrating RD exchange performed when PPDUs of which termination of transmission is synchronized are transmitted in a plurality of links according to an embodiment of the disclosure.

A single multi-link device may synchronize PPDUs transmitted in a plurality of links. Specifically, the single multi-link device may synchronize the ends of the PPDUs transmitted in the plurality of links. According to another detailed embodiment, the single multi-link device may synchronize the starts of the PPDUs transmitted in the plurality of links. Such an operation may be applied when there is constraint on the capability of transmission and reception of the multi-link device that receives a PPDU in at least any one of the plurality of links. The operation may be applied when the multi-link device that receives a PPDU in at least any one of the plurality of links is incapable of performing any one reception and any one transmission in parallel. In the case that, while the multi-link device performs reception in any one link, the multi-link device is capable of performing transmission in another link, the multi-link device may be referred to as a simultaneous transmit and receive (simultaneous transmission and reception) (STR) multi-link device. In the case that, while the multi-link device performs reception in any one link, the multi-link device is incapable of performing transmission in another link, the multi-link device may be referred to as a non-STR multi-link device. Therefore, the multi-link device that performs transmission with respect to a non-STR multi-link device in the plurality of links may transmit synchronized PPDUs.

RD exchange may be configured depending on whether a synchronized PPDU is transmitted.

In the case that synchronized PPDUs are transmitted in the plurality of links, the multi-link device may transmit RDG only in any one of the plurality of links. In this instance, an RD response may be transmitted only in the link in which RDG is transmitted. For example, in the case that the multi-link device transmits synchronized PPDUs in a first link and a second link, the multi-link device may include RDG in a PPDU transmitted in the first link. In this instance, a PPDU transmitted in response to the synchronized PPDU in the first link may be a first PPDU, and a PPDU transmitted in response to the synchronized PPDU in the second link may be a second PPDU. A first frame is transmitted in the first PPDU, a second frame is transmitted in the second PPDU, and the length of the first frame may be longer than the length of the second frame. For example, the first frame may include a data frame, and the second frame may include an ACK. In this instance, to synchronize the first PPDU and the second PPDU, a padding may need to be included in the second PPDU. Therefore, inefficiency of transmission may be increased.

In the case that synchronized PPDUs are transmitted in the plurality of links, RDG may or may not be transmitted in all of the plurality of links. In the case that the multi-link device transmits synchronized PPDUs in the plurality of links, the multi-link device may set, to the same value, the values of RDG/More PPDU subfields transmitted in the plurality of links. In the case that the multi-link device transmits synchronized PPDUs in the plurality of links, the multi-link device may set, to 1 or 0, all of the values of RDG/More PPDU subfields transmitted in the plurality of links. Through the above, efficiency of transmission may be increased. According to another detailed embodiment, RDG may or may not be transmitted in all of the plurality of links, irrespective of transmission of synchronized PPDUs.

According to another detailed embodiment, in the case that the multi-link device that receives PPDUs in the plurality of links is a non-STR multi-link device, RDG may or may not be transmitted in all of the plurality of links. In the case that the multi-link device that receives PPDUs in a plurality of links is a non-STR multi-link device, the multi-link device may set, to the same value, the values of RDG/More PPDU subfields transmitted in the plurality of links. In the case that the multi-link device that receives PPDUs in the plurality of links is a non-STR multi-link device, the multi-link device may set, to 1 or 0, the values of RDG/More PPDU subfields transmitted in the plurality of links. This is because, in the case that RD exchange is performed with a non-STR multi-link device only in any one of the links, transmission in another link may be restricted.

In the embodiment of FIG. 20, an AP multi-link device may include a first AP (AP 1) and a second AP (AP 2). A No-AP multi-link device may include a first station (STA 1) and a second station (STA 2). The first AP (AP 1) and the first station (STA 1) may be associated in a first link (Link 1), and the second AP (AP 2) and the second station (STA 2) may be associated in a second link (Link 2). In this instance, the first AP (AP 1) and the second AP (SP 2) may transmit synchronized PPDUs and may set the values of RDG/More PPDU subfields to the same value. Specifically, the first AP (AP 1) and the second AP (SP 2) may set the values of RDG/More PPDU subfields to 1, and may transmit synchronized PPDUs. In addition, the first station (STA 1) and the second station (STA 2) may set the values of RDG/More PPDU subfields to 1, and may transmit synchronized PPDUs. The first station (STA 1) and the second station (STA 2) may set the values of RDG/More PPDU subfields to 0, and may transmit additional synchronized PPDUs.

In addition, in the case that the multi-link device initiates RD exchange in the plurality of links and error recovery is performed in the plurality of links, the error recovery may be performed in parallel in the plurality of links. That is, error recovery may be performed in all of the plurality of links or error recovery may not be performed in all of the plurality of links. The embodiment may be applied when an RD initiator is a non-STR multi-link device, or when an RD responder is a non-STR device. In the case that error recovery is performed in any one link, it may be difficult to transmit synchronized PPDUs in the plurality of links.

In the case that the RD initiator is a multi-link device and the RD responder is also a multi-link device, and signaling related to RD exchange is transmitted in any one link, the signaling related to RD exchange may be applied to the corresponding link and the remaining links of the plurality of links. In this instance, the signaling related to RD exchange may include at least one piece of information among RDG, information related to an additional PPDU, and AC constraint signaling information that have been described above. In this instance, the RDG and the information related to an additional PPDU may be transmitted via the above-described RDG/More PPDU subfield. For example, the RD initiator that is a multi-link device and the RD responder that is a multi-link device may be associated in the first link and the second link. In this instance, in the case that RDG is transmitted in the first link, it is regarded that RDG is transmitted in the second link. In addition, if it is signaled that an additional PPDU is transmitted in the first link, it may be regarded that an additional PPDU is also transmitted in the second link. Such an embodiment may be applied when synchronized PPDUs are transmitted. In addition, even in the case that frame reception is successfully performed in any one of the links and frame reception fails in another link, signaling related to RD exchange may be applied to the corresponding link and the remaining links of the plurality of links. Accordingly, even in the case that transmission fails in any one of the links, RD exchange may be stably performed in the plurality of links.

In the IEEE 802.11be standard, 320 MHz is supported which is double the maximum bandwidth of 160 MHz supported in the existing 802.11 standard. In addition, in the standard prior to IEEE 802.11be, preamble puncturing is restrictively allowed only in a downlink (DL) MU PPDU, and a resource unit (RU) allocated to each station may be limited to one contiguous RU (996×2-tone size). In IEEE 802.11be, preamble puncturing is allowed even in uplink (UL) transmission, and it may be allowed to allocate, to each station, two or more RUs that are not contiguous. In this instance, a combination of some RUs may not be allowed in consideration of difficulty and efficiency of implementation.

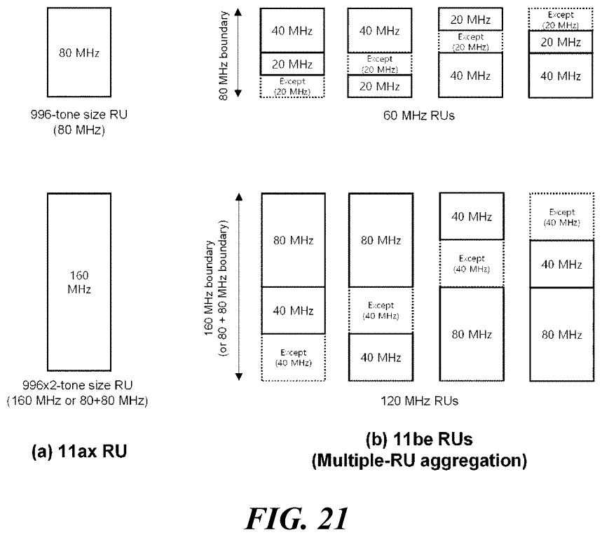

FIG. 21 is a diagram illustrating the configuration of an RU capable of being allocated to a single station according to IEEE 802.11ax and the configuration of an RU capable of being allocated to a single station according to an embodiment of the disclosure.

In addition, in the IEEE 802.11be standard, a small RU is also supported that is an RU having a size less than a 20 MHz 242-tone size. Specifically, in the IEEE 802.11be standard, a 26+52-tone size RU, a 26+52-tone size RU, and a 26+52-tone size RU may be allocated to a station. In FIG. 21, a description of a small RU is omitted.

(a) of FIG. 11 shows a 996-tone size RU in an 80 MHz channel and a 996×2-tone size RU in a 160 MHz channel in the IEEE 802.11ax standard. In IEEE 802.11ax, when an AP triggers, using a trigger frame, a station to perform UL transmission via a bandwidth exceeding 40 MHz, only a contiguous 80 MHz RU or a contiguous 160 MHz RU may be allocable to the station. In this instance, when the AP triggers the station to perform UL OFDMA transmission and allocates a bandwidth exceeding 40 MHz to the station, the AP may allocate only an 80 MHz RU to the station. In addition, in IEEE 802.11ax, in the case that an AP uses an RU exceeding 40 MHz when performing DL OFDMA, only an 80 MHz RU may be allowed.

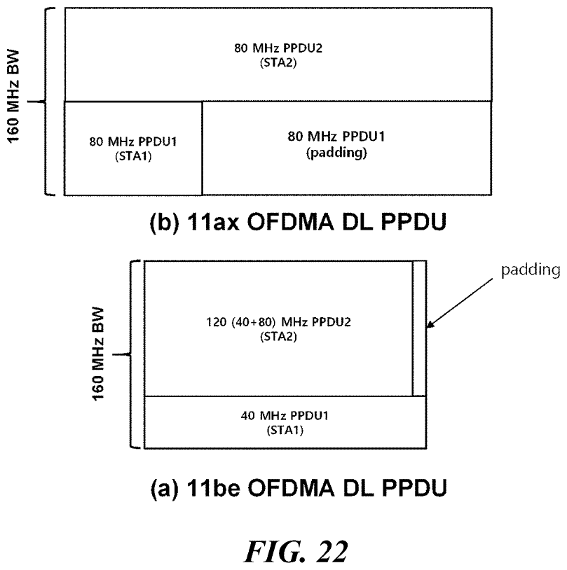

(b) of FIG. 11 shows four types of 60 MHz (242+484-tone size) RUs allowed in an 80 MHz channel of the IEEE 802.11be standard and four types of 120 MHz (484+996-tone size) RUs allowed in a 160 MHz channel. In the IEEE 802.11be standard, in the case that an AP uses a trigger frame to allocate an RU exceeding 40 MHz to a station, the AP may allocate, to the station, four types of 60 MHz RUs in addition to an 80 MHz RU. In addition, the AP may allocate, to the station, four types of 120 MHz RUs or four types of 160 MHz RUs. In addition, the various types of RUs may be used for a DL PPDU that uses an OFDMA, as well as, UL transmission. Effects obtained when the various types of RUs are used will be described with reference to FIG. 22.

FIG. 22 is a diagram illustrating an OFDMA DL PPDU used in the IEEE 802.11ax standard and an OFDMA DL PPDU used in an embodiment of the disclosure.

In FIG. 22, an AP transmits an OFDMA DL PPDU to a first station (STA1) and a second station (STA2). In this instance, the OFDMA DL PPDU may be configured with a first PPDU (PPDU 1) and a second PPDU (PPDU 2). It is shown that frequency bandwidths allocated to the first PPDU (PPDU1) and the second PPDU (PPDU2) are different due to a difference in a modulation & coding scheme (MCS) used when encoding the first PPDU (PPDU1) and the second PPDU (PPDU2). In the case that frequency bandwidths allocated to a plurality of PPDUs transmitted together are different from each other as described above, it may be efficient to use the minimum padding for the plurality of PPDUs. In this instance, if RUs that are selectable are restricted, transmission to any one station may be abandoned or an excessive padding may be needed.

(a) of FIG. 22 is a diagram illustrating that an AP uses allocation of only an RU allowed in the IEEE 802.11ax standard so as to transmit an OFDMA DL PPDU. An AP transmits a first PPDU (PPDU1) and a second PPDU (PPDU2) to both a first station (STA1) and a second station (STA2) using an 80 MHz RU. Therefore, a large amount of padding may be used for transmission of the first PPDU (PPDU1).

(b) of FIG. 22 is a diagram illustrating that an AP uses allocation of only an RU allowed in the IEEE 802.11ax standard so as to transmit an OFDMA DL PPDU. RUs having various bandwidths may be allocable, and thus a small amount of padding may be used in (b) of FIG. 22 compared to the case of (a) of FIG. 22. In the case that RUs having various bandwidths are used for a TB PPDU, as well as, for an OFDMA DL PPDU that has been described with reference to FIG. 22, the efficiency of transmission may be increased.

In the existing 802.11 standard, a back-off procedure may be performed based on CCA of a 20 MHz-primary channel. (In the specification, the 20 MHz-primary channel is a primary channel having a bandwidth of 20 MHz.) Specifically, even in the case of accessing a channel exceeding 20 MHz, accessing a channel other than the 20 MHz-primary channel may be allowed only when the result of CCA of the 20 MHz channel is idle. When the maximum bandwidth that a station is capable of using is increased, inefficiency of such a channel accessing method may be increased. Therefore, even in the case that the 20 MHz-primary channel is busy, there is a desire for a method of performing channel access via a channel other than the 20 MHz-primary channel.

In a detailed embodiment, a station may perform a backoff procedure using a subchannel, as opposed to using the 20 MHz primary channel. In this instance, the station may perform the backoff procedure using a subchannel, as opposed to the 20 MHz-primary channel, only when the 20 MHz-primary channel is detected as being busy. Specifically, in the case that the 20 MHz-primary channel is detected as being busy, and a destination station of a PPDU transmitted in the 20 MHz-primary channel is not the station, the station may perform the backoff procedure using a subchannel as opposed to the 20 MHz-primary channel. Therefore, only when the station decodes a preamble of a PPDU received in the 20 MHz-primary channel, the station is capable of performing a backoff procedure using a subchannel as opposed to the 20 MHz-primary channel. In addition, the station may determine an STA-ID of an EHT-SIG by decoding the preamble of the PPDU. According to another detailed embodiment, the station may determine an intended receiver of an MAC frame by decoding a first MAC frame of a PPDU. In addition, if it is identified that a PPDU that the station receives in the 20 MHz-primary channel is transmitted from a BSS different from a BSS that the station belongs to, that is, only in the case that the PPDU is determined as an inter-BSS PPDU, the station may be capable of performing a backoff procedure using a subchannel as opposed to the 20 MHz-primary channel. To this end, the station may determine a BSS color of a U-SIG or HE-SIG by decoding the preamble of the PPDU. In the case that the station determines that a PPDU transmitted in the 20 MHz-primary channel is an inter-BSS PPDU, the station may omit the above-described procedure that determines whether an intended receiver of the PPDU is the station.

In addition, in the case that a subchannel to which channel access is to be performed is idle during a DIFS, the station may start a backoff procedure using the subchannel as opposed to the 20 MHz-primary channel.

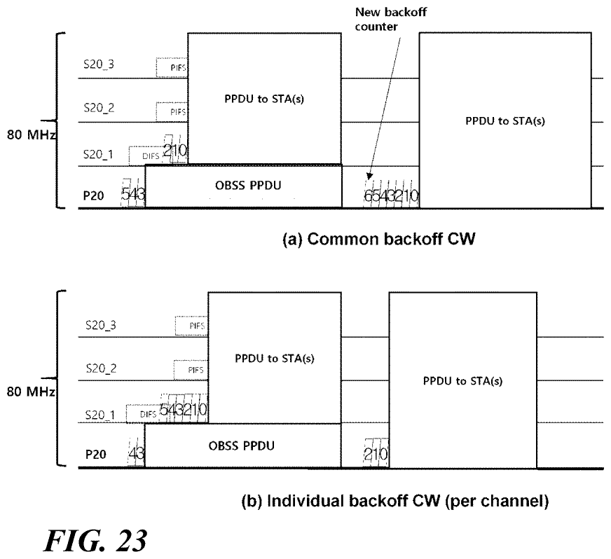

An embodiment for compensating for the time spent in decoding a preamble of a PPDU transmitted in the 20 MHz-primary channel may be applied. In a backoff procedure using a subchannel other than the 20 MHz-primary channel, a backoff counter may be reduced by a predetermined number and the backoff procedure may be started. In this instance, the predetermined number may be determined based on the time spent in decoding the preamble of the PPDU. For example, in the case that the time spent in decoding the preamble of the PPDU is 3 slots (e.g., 27 us), the predetermined number may be 3. According to another detailed embodiment, a backoff procedure may be performed without the above-described compensation. A method of performing a backoff procedure using a subchannel as opposed to the 20 MHz-primary channel will be described with reference to FIGS. 23 to 27.

FIG. 23 is a diagram illustrating a backoff procedure performed using a subchannel, as opposed to using a primary channel of 20 MHz, according to an embodiment of the disclosure.

In a backoff procedure, a station may perform CCA in units of slots. If a CCA result shows that a channel is idle, the station may reduce the value of a backoff counter by 1. If the CCA result shows that a channel is not idle, the station may maintain the value of the backoff counter. As described above, even when the backoff procedure is performed in a subchannel other than a 20 MHz-primary channel, CCA may be performed in units of slots. In addition, the bandwidth of a subchannel that is not the 20 MHz-primary channel may also be 20 MHz.

There may be two or more channels that are not the 20 MHz-primary channel and in which the station may perform a backoff procedure. For example, in the case that the station operates in an 80 MHz channel, the station may perform channel access based on the backoff procedure performed in three 20 MHz subchannels. The number of subchannels that are not the 20 MHz-primary channel and in which the station is capable of performing a backoff procedure may be determined based on the capability of the station. According to another detailed embodiment, the number of subchannels that are not the 20 MHz-primary channel and in which the station is capable of performing a backoff procedure may a predetermined number. In this instance, the predetermined number may be 1 or 2.

The station may separately set and manage a backoff counter used for the 20 MHz-primary channel and a backoff counter used for a subchannel that is not the 20 MHz-primary channel. Specifically, the station may change a backoff counter for each channel according to a channel access result for each channel. That is, in the case that the station successfully performs transmission in a channel, the station may obtain a new backoff counter for the corresponding channel within CW_min for the backoff counter for the corresponding channel. In the case that the station fails transmission in a channel, the station may increase the value of a CW for the backoff counter of the corresponding channel by two times or may obtain a new backoff counter for the corresponding channel within a CWmax. FIG. 23B is a diagram illustrating an example of setting and managing the value of a backoff counter for each subchannel, as described above. In FIG. 23B, a station may set the initial value of a backoff counter to 4 in a 20 MHz-primary channel (P20), and may set the initial value of a backoff counter to 5 in a first subchannel (S20_1). The station transmits a PPDU in the first subchannel (S20_1), a second subchannel (S20_2), and a third subchannel (S20_3), and then the station performs channel access again in the 20 MHz-primary channel. In this instance, the station uses the backoff counter for the 20 MHz-primary channel as it is.

The station may set and manage a single backoff counter used in common for the 20 MHz-primary channel and a subchannel that is not the 20 MHz-primary channel. FIG. 23A is a diagram illustrating an example of a single common backoff counter that a station uses in the 20 MHz-primary channel and the subchannel that is not the 20 MHz-primary channel, as described above. In FIG. 23A, the station may set the initial value of a backoff counter to 5 in the 20 MHz-primary channel (P20). The 20 Hz-primary channel (P20) is idle during three slots in the primary channel, the station may reduce the backoff counter by 3. Subsequently, the 20 MHz-primary channel (P20) is not idle and the first subchannel (S20_1) is idle during a DIFS, and thus, the station may start a backoff procedure in the first subchannel (S20_1). In this instance, the first subchannel (S20_1) is idle during three slots, and the second subchannel (S20_2) and the third subchannel (S20_3) are idle during a PIFS, and thus the station may transmit a PPDU in the first subchannel (S20_1), the second subchannel (S20_2), and the third subchannel (S20_3). Subsequently, the station obtains a new backoff counter and performs channel access. Unlike the embodiment of FIG. 20A, if it is detected that the first subchannel (S20_1) is not idle and the station is capable of performing a backoff procedure in the second subchannel (S20_2), the station may perform a backoff procedure in the second subchannel (S20_2). In this instance, in the case that the station is incapable of performing a backoff procedure even in the second subchannel (S20_2), the station may be on standby until the 20 MHz-primary channel (P20) or the first subchannel (S20_1) becomes idle.

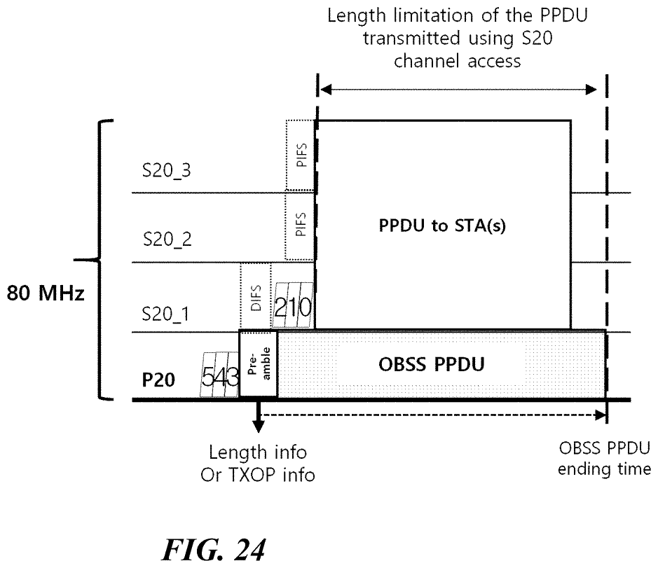

In the case that the station successfully performs channel access in a subchannel as opposed to the 20 MHz-primary channel, and transmits a PPDU, the length of the PPDU may be limited. First, while the station performs channel access and transmission via a subchannel as opposed to the 20 MHz-primary channel, an AP that is associated with the station may also be incapable of performing transmission and reception in the 20 MHz-primary channel. Therefore, scanning performed via the 20 MHz-primary channel or the like may be incapable of being performed. In addition, an inter-BSS PPDU transmitted via the 20 MHz-primary channel may not be received and thus, configuration of an NAV based on the inter-BSS PPDU may not be performed. Therefore, in the case that the station successfully performs channel access in a subchannel as opposed to the 20 MHz-primary channel and transmits a PPDU, the length of the PPDU may need to be restricted. In addition, even in the case of considering fairness with a station according to the existing standard, if the station successfully performs channel access in a subchannel as opposed to the 20 MHz-primary channel and transmits a PPDU, the length of the PPDU may need to be restricted. In addition, the number of subchannels in which the station is capable of performing a backoff procedure may be restricted as described above. The embodiments will be described in detail with reference to FIG. 24.

FIG. 24 is a diagram illustrating that the length of a PPDU is restricted when a station successfully performs channel access in a subchannel as opposed to a 20 MHz-primary channel according to an embodiment of the disclosure.

When a station successfully performs channel access in a subchannel as opposed to a 20 MHz-primary channel and transmits a PPDU, the station may terminate transmission of a PPDU at or before the point in time determined based on transmission of an inter-BSS PPDU transmitted in the 20 MHz-primary channel. In this instance, the point in time determined based on the transmission of the inter-BSS PPDU may be an end point of the inter-BSS PPDU. According to another detailed embodiment, the point in time determined based on the transmission of an inter-BSS PPDU may be the point in time at which transmission of an ACK with respect to the transmission of the inter-BSS PPDU is completed. Based on the value of a length field of an L-SIG of the inter-BSS PPDU, the station may determine the point in time determined based on the transmission of the inter-BSS PPDU. In addition, based on the value of a TXOP field of a signaling field of the inter-BSS PPDU, the station may determine the point in time determined based on the transmission of the inter-BSS PPDU.

The station in the embodiment of FIG. 24 may transmit a PPDU via a first subchannel (S20_1), a second subchannel (S20_2), and a third subchannel (S20_3) within the length of an inter-BSS PPDU (OBSS PPDU) transmitted in the 20 MHz-primary channel (P20).

In the case that the station is allowed to perform channel access in a subchannel as opposed to the 20 MHz-primary channel, an AP may need to perform detection of a PPDU in another subchannel, in addition to the 20 MHz-primary channel, in order to receive a PPDU. Specifically, in the case that an inter-BSS PPDU is transmitted in the 20 MHz-primary channel, the AP may perform detection of a PPDU in a subchannel in addition to detection in the 20 MHz-primary channel. PPDU detection may be detection of a preamble of a PPDU. According to the embodiments, the AP may detect a PPDU in a subchannel in which an inter-BSS PPDU is not transmitted. In this instance, the order of subchannels in which the AP is to detect a PPDU may be determined in advance. For example, in the case that an inter-BSS PPDU having a bandwidth of 40 MHz is transmitted in the 20 MHz-primary channel, the AP may detect a PPDU in a subchannel that is 40 MHz distant from the 20 MHz-primary channel.

As described above, in order to receive a PPDU transmitted in a channel excluding the 20 MHz-primary channel, the station may need to perform additional processing. Therefore, the station may not support reception of a PPDU transmitted in a channel excluding the 20 MHz-primary channel. The station may signal whether reception of a PPDU transmitted in a channel excluding the 20 MHz-primary channel is supported. Specifically, using a capability element, the station may signal, to the AP, whether reception of a PPDU transmitted in a channel excluding the 20 MHz-primary channel is supported. In the case that the AP configures a PPDU in a channel excluding the 20 MHz-primary channel, the AP may include, in the PPDU, only a frame of which a receiver is only the station that signals that reception of a PPDU transmitted in a channel excluding the 20 MHz-primary channel is supported.

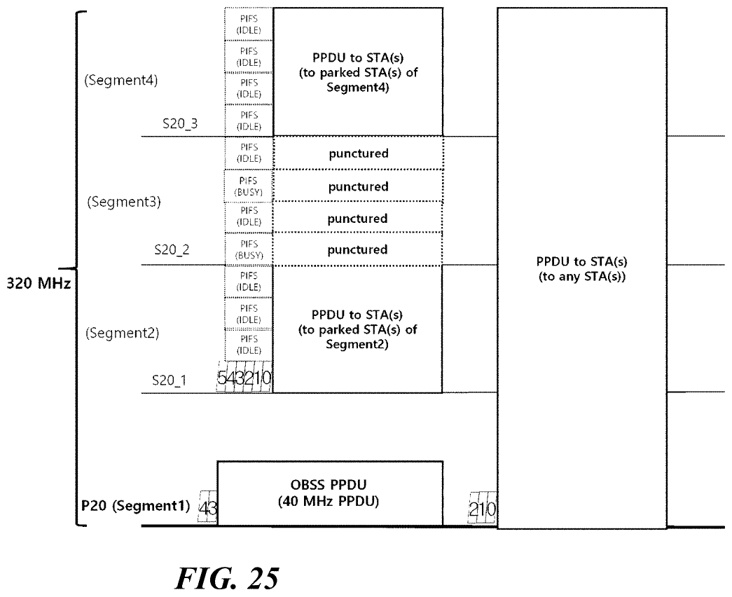

In the IEEE 802.11be standard, segments are divided based on a unit of 80 MHz, and this is referred to as an 80 MHz segment. In addition, it is defined that a signaling field, for example, an EHT-SIG or a U-SIG, different for each 80 MHz segment may be transmitted in a single PPDU. With reference to FIG. 25, channel access performed by a station via a segment that does not include a 20 MHz-primary channel will be described.

FIG. 25 is a diagram illustrating that a station performs channel access via a subchannel of a segment, as opposed to a main segment, when a 20 MHz-primary channel is not idle according to an embodiment of the disclosure.

The above-described station may perform channel access via a segment that does not include the 20 MHz-primary channel. Specifically, in the case that the 20 MHz-primary channel is not idle, the station may perform channel access via a segment that does not include the 20 MHz-primary channel.

According to another detailed embodiment, the station may be configured, by an AP, to receive a preamble via a subchannel different from the 20 MH-primary channel, and to perform decoding the same. In this instance, the station may perform channel access via a segment that does not include the 20 MHz-primary channel. In the embodiment, the station may perform channel access via a segment that does not include the 20 MHz-primary channel, without detecting whether a PPDU is transmitted in the 20 MHz-primary channel. As described above, transmission via a segment that does not include the 20 MHz-primary channel may be referred to as a subchannel selective transmission (SST). In addition, a station that receives a PPDU and a preamble of the PPDU via a segment that does not include the 20 MHz-primary channel may be referred to as a parked station.

For each segment, one subchannel to which channel access is performed may be designated. In the case that the 20 MHz-primary channel is not idle, the station may perform channel access in a designated subchannel to which channel access is to be performed in a segment that does not include the 20 MHz-primary channel.

In the embodiment of FIG. 15, the AP detects an inter-BSS PPDU having a bandwidth of 40 MHz transmitted in the 20 MHz-primary channel (P20). The AP may perform a backoff procedure in a first subchannel (S20_1) of a second segment (segment 2). In this instance, the first subchannel (S20_1) may be a channel designated as a channel in which a backoff procedure is to be performed when a backoff procedure is performed in the second segment (segment2). A station parked in the second segment (b) may detect a preamble of a PPDU in the first subchannel (S20_1). In this instance, the station parked in the second segment (segment2) may be on standby for reception of a PPDU in the first subchannel (S20_1), irrespective of whether the channel in which the AP performs the backoff procedure is the 20 MHz-primary channel (P20) or the first subchannel (S20_1). In addition, the station parked in the second segment (segment2) detects a preamble of an EHT MU PPDU or HE MU PPDU in the first subchannel (S20_1), and the station parked in the second segment (segment2) may decode a preamble of a PPDU in a subchannel other than the first subchannel (S20_1) of the second segment, in order to determine an RU and a special stream of a PPDU transmitted to the station.

The AP may transmit a PPDU via a subchannel that is in an idle state during a PIFS prior to the point in time at which a backoff procedure is terminated in the second segment (segment2), as well as, in the second segment (segment2). In this instance, depending on whether a designated channel in which a backoff procedure is to be performed in each segment is idle during a PIFS prior to the point in time at which a backoff procedure is terminated, the AP may determine whether to transmit a PPDU in each segment. Specifically, in the case that a designated channel in which a backoff procedure is to be performed in each segment is idle during a PIFS prior to the point in time at which a backoff procedure is terminated, the AP may transmit a PPDU in the corresponding segment. In the case that a designated channel in which a backoff procedure is to be performed in each segment during is not idle during a PIFS prior to the point in time at which a backoff procedure is terminated, the AP may not transmit a PPDU in the corresponding segment.

In the embodiment of FIG. 25, it is detected that a second subchannel (S20_2) is not idle, the second subchannel being a subchannel in which a backoff procedure is to be performed in a third segment (segment3) during a PIFS prior to the point in time at which the backoff procedure is terminated in the second segment (segment2). In addition, it is detected that a third subchannel (S20_3) is idle, the third subchannel being a subchannel in which a backoff procedure is to be performed in a fourth segment (segment4) during a PIFS prior to the point in time at which the backoff procedure is terminated in the second segment (segment2). Therefore, the AP may transmit a PPDU in the second segment (segment2) and the fourth segment (segment4).

As described above, the length of a PPDU transmitted, an intended receiver of a MAC frame included in a PPDU, and an RU allocated to a station that receives a PPDU may be restricted.

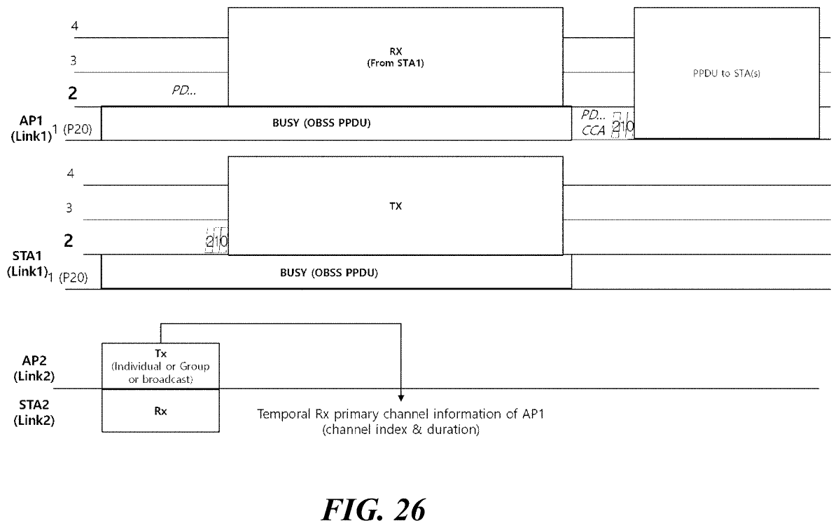

Although the above-described embodiments have been described by taking transmission performed by an AP as an example, the embodiments may be equally applied to a non-AP station. This will be described in detail with reference to FIG. 26.

FIG. 26 is a diagram illustrating that a first AP of a multi-link device signals, via a second AP, that the first AP is capable of performing reception via a sub-channel as opposed to a 20 MHz-primary channel according to an embodiment of the disclosure.

In the case that a first AP of a multi-link device detects that a 20 MHz-primary channel of the first AP is not idle, the first AP may signal that a backoff procedure needs to be performed via a subchannel that is not the 20 MHz-primary channel, via a second AP that is another AP of the multi-link device. In this instance, the first AP may indicate, using the second AP, a subchannel in which a backoff procedure is to be performed. According to another detailed embodiment, the first AP may not perform, using the second AP, signaling of a subchannel in which a backoff procedure is to be performed. In this instance, a station may perform a backoff procedure using a predetermined subchannel.

In addition, the first AP may signal, using the second AP, a period of time during which the first AP is on standby for reception in a subchannel as opposed to the 20 MHz-primary channel. The station may determine the length of a UL PPDU based on the signaled standby time. Specifically, the station may determine the length of the UL PPDU so that transmission of the UL PPDU does not exceed the signaled standby time. According to another detailed embodiment, the station may determine the length of a UL PPDU to exceed the signaled standby time so that a response to the UL PPDU, for example, an ACK, is completed.

According to the embodiments, the second AP may transmit a control frame including information related to a standby time for reception, for example, information related to a subchannel that is not the 20 MHz-primary channel of the first AP and information related to a standby time. In this instance, a receiver address of the control frame may be the MAC address of a predetermined station. In this instance, only the station corresponding to the receiver address may perform a backoff procedure in a subchannel as opposed to the 20 MHz-primary channel. According to another detailed embodiment, the receiver address may be a group address. In this instance, only a station corresponding to the group address may perform a backoff procedure in a subchannel as opposed to the 20 MHz-primary channel. In this instance, a plurality of stations may be in contention for channel access. According to another detailed embodiment, the receiver address may be a broadcast address. A station that does not correspond to the receiver address may maintain a power-saving state of a power-saving operation during a standby time for reception.

In the above-described embodiments, a single or a plurality of control frames including the information related to a standby time for reception may be transmitted. A control frame including information related to standby for reception may be transmitted solely. According to another detailed embodiment, a control frame including information related to standby for reception may be transmitted together with a data frame, another control frame, or a management frame.

In addition, the second AP may perform signaling in association with a TID that may be transmitted based on a backoff procedure of a subchannel as opposed to the 20 MHz-primary channel. Specifically, the above-described control frame may include information related to a TID to be used in uplink transmission transmitted based on a backoff procedure of a subchannel as opposed to the 20 MHz-primary channel. In this instance, the information related to a TID may be expressed by an 8-bit field. Specifically, the bits of the 8-bit field may correspond to TID values ranging 0 to 7, respectively. In the case that the value of each bit is 1, this may indicate that a TID corresponding to the corresponding bit is allowed. In the case that the value of a subfield is 111111112b, this may indicate that TID values ranging 0 to 7 are allowed. According to another detailed embodiment, in the case that the value of a subfield is 111111112b, this may indicate that transmission of all TIDs is allowed. According to another detailed embodiment, information related to a TID may be expressed by a 16-bit field. Specifically, the bits of the 16-bit field may correspond to TID values ranging 0 to 15, respectively. In the case that the value of each value is 1, this may indicate that a TID corresponding to the corresponding bit is allowed.

In addition, the second AP may perform signaling of an EDCA parameter used in a backoff procedure of a subchannel as opposed to the 20 MHz-primary channel. Specifically, the above-described control frame may include information associated with an EDCA parameter used for a backoff procedure of a subchannel as opposed to the 20 MHz-primary channel. Using a signaled backoff parameter, a first station (STA1) may perform a backoff procedure in a subchannel as opposed to the 20 MHz-primary channel. According to a detailed embodiment, although the first station (STA1) is using an MU EDCA parameter, the first station (STA1) may be capable of performing a backoff procedure using the signaled backoff parameter, in a subchannel as opposed to the 20 MHz-primary channel. In this instance, after the first station (STA1) completes a backoff procedure in a subchannel as opposed to the 20 MHz-primary channel, or in the case that the first station (STA1) performs a backoff procedure in the 20 MHz-primary channel, the first station (STA1) may perform a backoff procedure again using the MU-EDCA parameter.

In the embodiment of FIG. 16, an AP multi-link device may include a first AP (AP1) and a second AP (AP2). A non-AP multi-link device may include a first station (STA1) and a second station (STA2). The first AP (AP1) and the first station (STA1) may be associated in a first link (Link1), and the second AP (AP2) and the second station (STA2) may be associated in a second link (Link1). In this instance, the 20 MHz-primary channel of the first AP (AP1) is detected as not being idle. The second AP (AP2) may transmit, to the second station (STA2), information related to the first AP (AP1)'s standby for reception, for example, information associated with a reception standby subchannel and a reception standby time. In this instance, using a control frame, the second AP (AP2) may transmit information related to standby for reception in the second link (Link2). In this instance, a receiver address of the control frame may correspond to the first station (STA1). According to another detailed embodiment, the receiver address of the control frame may be a MAC address of a non-AP multi-link device including the first station (STA1) and the second station (STA2). According to another detailed embodiment, the receiver address of the control frame may be a group address. The first station (STA1) may perform a backoff procedure in a subchannel as opposed to the 20 MHz-primary channel (P20). After the backoff procedure is successfully performed, transmission of a PPDU to the first AP (AP1) is performed.

An AP according to an embodiment of the disclosure may park a station associated with the AP in a segment that does not correspond to an 80 MHz-primary channel. In this instance, in the case of the station associated with the AP, a subchannel in the segment in which the station is parked may operate as if the subchannel were the 20 MHz-primary channel. Specifically, the station associated with the AP may detect a preamble of a PPDU in the segment in which the station is parked. In addition, although the AP transmits a PPDU having a bandwidth of 320 MHz, the station associated with the AP may perform reception as if the PPDU would have a bandwidth of 80 MHz bandwidth or a bandwidth of 160 MHz. This is because a signaling field of a PPDU, for example, a U-SIG field and an EHT-SIG field, may be transmitted with a different content for each segment, as described above. In addition, the signaling field may be transmitted with a different content for each segment and thus, the length of the signaling field may be prevented from being excessively extended.

A subchannel that is used as if the subchannel were the 20 MHz-primary channel in a segment in which the station associated with the AP is parked is referred to as a virtual primary channel. In this instance, preamble puncturing may not be performed in the virtual primary channel. In addition, a single virtual primary channel may be designated for each segment. Specifically, a 20 MHz channel which is the lowest in the segment may be designated as a virtual primary channel. In the case that the AP is incapable of transmitting a preamble of a PPDU in the virtual primary channel in any one segment, the AP may perform puncturing of the corresponding segment. According to another detailed embodiment, in the case that an AP is incapable of transmitting a preamble of a PPDU in a virtual primary channel in any one segment, the AP may transmit a PPDU to a station that is not parked in the corresponding segment. That is, in the case that the AP is incapable of transmitting a preamble of a PPDU in a virtual primary channel in any one segment, a station parked in the corresponding segment may be incapable of receiving a PPDU. In addition, in the case that the AP performs puncturing of any one segment, the AP may not trigger a station parked in the corresponding segment to perform uplink transmission. Specifically, the AP may not transmit, to the station parked in the corresponding segment, a trigger frame that allocates an RU for uplink transmission.

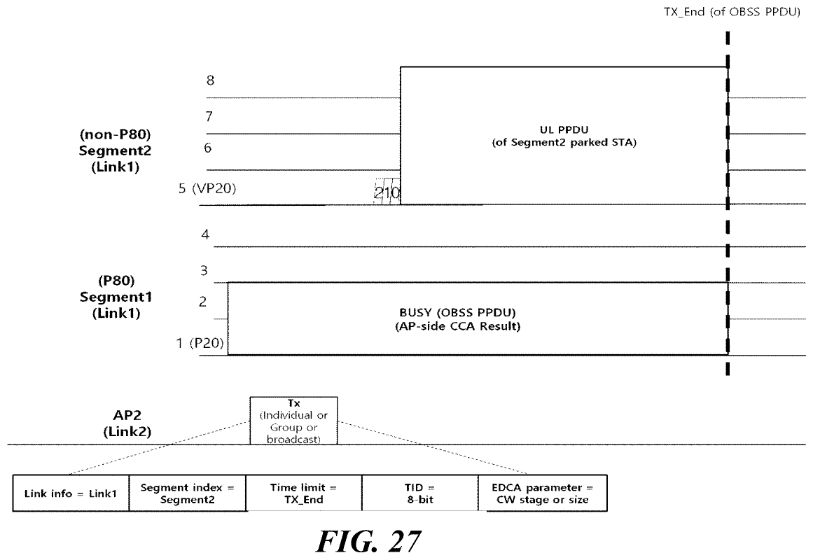

In the case that a station parked in a segment that does not correspond to an 80 MHz-primary channel is restricted to perform channel access in a 20 MHz-primary channel as opposed to a virtual primary channel, a channel in which the AP performs transmission and a channel in which the AP detects a preamble of a PPDU may be changed. In addition, a channel in which the station performs backoff for uplink transmission and a channel in which the station detects a preamble of a PPDU may also be changed. Therefore, while the AP performs backoff for a station parked in a segment that does not correspond to the 80 MHz primary channel, the AP may not receive a PPDU transmitted by the station parked in the segment that does not correspond to the 80 MHz-primary channel. Therefore, the AP may allow the station parked in the segment that does not correspond to the 80 MHz-primary channel to perform a backoff procedure for uplink transmission in the segment in which the station is parked. This will be described with reference to FIG. 27.

FIG. 27 is a diagram illustrating that an AP of an AP multi-link device allows a station, which is parked in a segment that does not correspond to an 80 MHz-primary channel, to perform a backoff procedure for uplink transmission in the segment in which the station is parked, according to an embodiment.

The station that detects that an inter-BSS PPDU is transmitted in a 20 MHz-primary channel may allow a station, parked in a segment that does not correspond to an 80 MHz-primary channel, to perform a backoff procedure for uplink transmission in a virtual primary channel. In this instance, based on the bandwidth of the inter-BSS PPDU transmitted in the 20 MHz-primary channel, the AP may determine a segment in which a station is to perform a backoff procedure for uplink transmission. Specifically, the AP may determine a segment in which an inter-BSS PPDU is not transmitted as a segment in which a station is to perform a backoff procedure for uplink transmission. In this instance, the AP may allow a station parked in the determined segment to perform a backoff procedure using a virtual primary channel of the determined segment. In this instance, the AP may allow only some of the stations parked in the determined segment to perform a backoff procedure using a virtual primary channel. For example, in the case that an inter-BSS PPDU having a bandwidth of 160 MHz is transmitted via two segments, the AP may allow stations parked in the remaining two segments to perform a backoff procedure using a virtual primary channel. In this instance, the AP may allow only a station parked in one of the two segments to perform a backoff procedure using a virtual primary channel.

In addition, the AP may signal, using a 2-bit subfield, a segment in which a backoff procedure performed using a virtual primary channel is allowed. For ease of description, a segment in which a backoff procedure performed using a virtual primary channel is allowed is referred to as a designated segment. In this instance, the subfield may indicate the index of the designated segment. For example, in the case that the value of the subfield is 0, the subfield may indicate that a segment corresponding to the lowest frequency band is a designated segment. In the case that the value of the subfield is 3, the subfield may indicate that a segment corresponding to the highest frequency band is a designated segment. According to another detailed embodiment, in the case that the value of the subfield is 0, the subfield may indicate that a segment corresponding to an 80 MHz-primary channel is a designated segment. In this instance, the value of the subfield is 1, the subfield may indicate that a segment corresponding to an 80 MHz-subchannel is a designated segment. In addition, the value of the subfield is 2 or 3, the subfield may indicate that each of two segments corresponding to an 160 MHz-subchannel is a designated segment.

In addition, the AP may signal, to a station, PPDU reception standby time information that is information associated with a time in which the AP is on standby for reception of a PPDU in a virtual primary channel. Specifically, the AP may signal, to the station, the PPDU reception standby time information together with a designate segment. In this instance, based on the PPDU reception standby time information, the station may determine the length of a PPDU transmitted. Specifically, the station may determine the length of a PPDU so that a PPDU transmission complete time does not exceed the PPDU reception standby time. According to another detailed embodiment, the station may determine the length of a PPDU so that a PPDU and a PPDU response complete time do not exceed the PPDU reception standby time. In this instance, the response to a PPDU may be an ACK, for example, an ACK frame and a BlockACK frame.

In addition, the AP may signal, to the station, the type of traffic transmitted based on a backoff procedure in a virtual primary channel. Detailed operations of the AP and the station may be the same as the operations of the AP and the station that have been described with reference to FIG. 26. In addition, the AP may signal, to the station, an EDCA parameter to be used when the station performs a backoff procedure in a virtual primary channel. Detailed operations of the AP and the station may be the same as the operations of the AP and the station that have been described with reference to FIG. 26. In this instance, an EDCA parameter used when the station performs a backoff procedure in an 20 MHz-primary channel and an EDCA parameter used when the station performs a backoff procedure in the virtual primary channel may be independent from each other. For example, a backoff counter used when the station performs a backoff procedure in the 20 MHz-primary channel and a backoff counter used when the station performs a backoff procedure in the virtual primary channel may be independent from each other.

In addition, an AP multi-link device may transmit pieces of above-described information to a station associated with a first AP via a second AP of the AP multi-link device.

In addition, based on the above-described reception standby time information, a station parked in a segment, which is different from a segment including a virtual primary channel in which performance of a backoff procedure is allowed by the AP, may enter a power-saving state of a power-saving operation. Specifically, the station parked in the segment, which is different from the segment including the virtual primary channel that the AP allows a backoff procedure to be performed therein, may maintain the power-saving state during the reception standby time.

In the embodiment of FIG. 27, an AP multi-link device may include a first AP and a second AP. In this instance, the first AP may detect that an inter-BSS PPDU is transmitted in the 20 MHz-primary channel (P20) of the first AP. The first AP (AP1) may signal, via the second AP (AP2), that a backoff procedure for uplink transmission is allowed in a virtual primary channel of a second segment (segment2) as opposed to a first segment (segment1) including the 20 MHz-primary channel (P20). In this instance, the first AP (AP1) may signal a link in which the first AP (AP1) operates, an uplink transmission standby time (time limit), a TID of traffic to be transmitted in uplink transmission, and an EDCA parameter to be used for a backoff procedure for uplink transmission, together with the information indicating that a backoff procedure for uplink transmission is allowed in the second segment.

Although the disclosure has been described using WLAN communication as an example as described above, the disclosure is not limited thereto and may be equally applied to other communication systems such as cellular communication. In addition, although the methods, devices, and systems of the disclosure have been described in connection with certain embodiments, some or all of the components, operations of the disclosure may be implemented using a computer system having a general-purpose hardware architecture.

The features, structures, effects, etc. described in the above embodiments are included in at least one embodiment of the disclosure and are not necessarily limited to one embodiment. Further, the features, structures, effects, etc. illustrated in each embodiment may be combined or modified for other embodiments by one of ordinary skill in the art to which the embodiments belong. Accordingly, the contents relating to these combinations and modifications should be construed as falling within the scope of the disclosure.

Although described above with a focus on the embodiment, this is only an example and is not limited to the disclosure, and those of ordinary skill in the art to which the present invention pertains will appreciate that various modifications and applications not exemplified above are possible without departing from the essential characteristics of the present embodiment. For example, each component specifically illustrated in the embodiment is one that may be modified and implemented. In addition, the differences relating to these modifications and applications should be construed as falling within the scope of the disclosure as defined in the appended claims.

1. A multi-link device that uses a plurality of links, the device comprising:
a transceiver; and
a processor,
wherein the processor is configured to receive a first physical layer protocol data unit (PPDU) including reverse direction (RD) grant and an access category (AC) constraint signaling from a station that is a transmission opportunity (TXOP) holder or a service period (SP) source in any one of the plurality of links, and
to transmit, based on the AC constraint signaling in the any one link, a second PPDU to the station in response to the first PPDU, and
wherein the AC constraint signaling indicates whether a traffic identifier (TID) or AC of a frame to be included in the second PPDU is restricted.

2. The multi-link device of claim 1, wherein an AC or a TID is mapped to any one of the plurality of links,
wherein the multi-link device transmits a frame based on the mapped AC or TID in the any one link, and
wherein, in a case that the AC constraint signaling indicates that any TID is allowed as a TID of a data frame to be included in the second PPDU, and the multi-link device includes a data frame in the second PPDU, the processor is configured to include a data frame corresponding to a TID mapped to the any one link in the second PPDU, and not to include a data frame corresponding to a TID that is not mapped to the any one link in the second PPDU.

3. The device of claim 1, wherein an AC or a TID is mapped to any one of the plurality of links,
wherein the multi-link device transmits a frame based on the mapped AC or TID in the any one link, and
wherein, in a case that the AC constraint signaling indicates that an AC or TID of a frame to be included in the second PPDU is restricted, and the multi-link device includes a data frame in the second PPDU, the processor is configured to include, in the second PPDU, a data frame corresponding to an AC or a TID that is mapped to the any one link and that has a priority higher than or equal to a priority of an AC or TID of a frame received from the station, and not to include, in the second PPDU, a data frame corresponding to a TID or AC that is not mapped to the any one link or has a lower priority than the priority of the AC or TID of the frame received from the station.

4. The device of claim 3, wherein, when the multi-link device receives a plurality of frames from the station, the priority of the AC or TID of the frame received from the station is a lowest priority among priorities of the plurality of frames.

5. The device of claim 1, wherein the processor regards an AC of a management frame as a predetermined value.

6. The device of claim 1, wherein, in a case of including a BlockAck frame in the second PPDU, the processor is configured to determine an AC of the BlockAck frame based on a TID field of the BlockAck frame, and
in a case of including a BlockAckReq frame in the second PPDU, the processor is configured to determine an AC of the BlockAckReq frame based on a TID field of the BlockAckReq frame.

7. The device of claim 1, wherein the AC constraint signaling is included in a medium access control (MAC) header of a frame included in a PPDU that includes the RD grant.

8. An operation method of a multi-link device that uses a plurality of links, the method comprising:
receiving a first physical layer protocol data unit (PPDU) including reverse direction (RD) grant and an access category (AC) constraint signaling from a station that is a transmission opportunity (TXOP) holder or a service period (SP) source in any one of the plurality of links; and
transmitting, based on the AC constraint signaling in the any one link, a second PPDU to the station in response to the first PPDU, and
wherein the AC constraint signaling indicates whether a traffic identifier (TID) or AC of a frame to be included in the second PPDU is restricted.

9. The method of claim 8, wherein an AC or a TID is mapped to any one of the plurality of links,
wherein the multi-link device transmits a frame based on the mapped AC or TID in the any one link, and
wherein the transmitting the second PPDU to the station comprises including a data frame corresponding to a TID mapped to the any one link in the second PPDU, and
not including a data frame corresponding to a TID that is not mapped to the any one link in the second PPDU, in a case that the AC constraint signaling indicates that any TID is allowed as a TID of a data frame to be included in the second PPDU, and the multi-link device includes a data frame in the second PPDU.

10. The method of claim 8, wherein an AC or a TID is mapped to any one of the plurality of links,
wherein the multi-link device transmits a frame based on the mapped AC or TID in the any one link, and
wherein the transmitting the second PPDU to the station comprises including, in the second PPDU, a data frame corresponding to an AC or a TID that is mapped to the any one link and that has a priority higher than or equal to a priority of an AC or a TID of a frame received from the station, and
not including, in the second PPDU, a data frame corresponding to a TID or AC that is not mapped to the any one link or has a lower priority than the priority of the AC or TID of the frame received from the station, in a case that the AC constraint signaling indicates that an AC or a TID of a frame to be included in the second PPDU is restricted, and the multi-link device includes a data frame in the second PPDU.

11. The method of claim 10, wherein, when the multi-link device receives a plurality of frames from the station, the priority of the AC or TID of the frame received from the station is a lowest priority among priorities of the plurality of frames.

12. The method of claim 8, wherein the transmitting the second PPDU to the station comprises regarding an AC of a management frame as a predetermined value.

13. The method of claim 8, wherein the transmitting the second PPDU to the station comprises, in a case of including a BlockAck frame in the second PPDU, determining an AC of the BlockAck frame based on a TID field of the BlockAck frame, and in a case of including a BlockAckReq frame in the second PPDU, determining an AC of the BlockAckReq frame based on a TID field of the BlockAckReq frame.

14. The method of claim 8, wherein the AC constraint signaling is included in a medium access control (MAC) header of a frame included in a PPDU including the RD grant.
